(19) United States
(12) Patent Application Publication
(10) Pub. No.: US 2026/0242306 A1
(43) Pub. Date: Aug. 20, 2026

(54) PROPERTIES, APPLICATIONS, AND COMPOSITION OF LIQUID EXTRACT FROM FEEDSTOCK BY A CHEMO-MECHANICAL CELLULAR EXPLOSION PROCESS

(71) Applicant: IFG Technologies, LLC, Coeur d'Alene, ID (US)

(72) Inventors: Timothy Wagler, West Lafayette, IN (US); Chester Gunn, Doerun, GA (US)

(21) Appl. No.: 18/852,685

(22) PCT Filed: Mar. 30, 2023
(86) PCT No.: PCT/US2023/016832

§ 371 Date: Sep. 30, 2024

Related U.S. Application Data
(60) Provisional application No. 63/325,188, filed on Mar. 30, 2022.

(51) Int. Cl. C05F 11/02

(52) U.S. Cl. CPC C05F 11/02

(57) ABSTRACT

Disclosed herein is a liquid product obtained from a biomass material, the liquid product comprising one or more of water, bio-stimulant compounds, bio-nutrient compounds, minerals, amino acids, nano cellulose, lignin, and hemicellulose, tannins, terpenes, and polyphenol compounds, and primary and secondary metabolites. Also disclosed herein is a liquid product obtained from a biomass material undergoing chemo-mechanical cellular explosion process. The process comprises combining one or more additives with a fibrous material, the fibrous material comprising water and lignin, and conditioning the fibrous material by applying a shear force to increase a pressure and a temperature, vaporizing a second portion of water in the fibrous material by fractionating the fibrous material, and exposing the fibrous material to a reduced pressure to induce the exploding of the plurality of cells in the fibrous material to obtain a liquid product.

### CROSS-REFERENCE TO RELATED APPLICATIONS

This application claims the benefit of U.S. Provisional Application Ser. No. 63/325,188, filed on 30 Mar. 2022, which is incorporated herein by reference in its entirety as if fully set forth below.

### FIELD OF THE DISCLOSURE

The present disclosure relates generally to liquid products extracted from a biomass product by a chemo-mechanical cellular explosion process.

### BACKGROUND

Processing raw materials into useable and value-added products is a constant area of human innovation that is consistently developing. Wood or other lignocellulosic materials, for example, can be processed into useable and value-added products such as paper, packaging, biofuel, pellets, food and/or medical bioactives and the like. A current problem with such processes, as with all processes, is high energy inputs and the addition of harsh chemicals required to obtain valuable products. In processing lignocellulosic materials, large amounts of shaft work are required to mill the materials to desirable sizes, and large amounts of added heat and chemicals (e.g., strong acids or bases) are necessary to remove excess water content and inhibiting constituents. Additionally, the temperature increase by the added heat can vaporize and/or cause a conversion of organic matter raw materials into harmful volatile organic compounds (VOCs), which are then released into the atmosphere. In some cases, additional energy- and cost-intensive measures must be undertaken to further process the released VOCs and other hazardous waste generated during the processes. Producing useful products in an energy-efficient manner, without hazardous and harsh chemicals, is desirable to expand the design space of a number of industries, such as construction/infrastructure, building, energy, energy production, packaging, lawn/garden products, farming, food production, antipollution, and the like. Additionally, preserving the content of the raw organic materials, such as VOCs, nutrients, organic acids, and the like, is desirable to obtain other useful co-products during processing. Such co-products present attractive opportunities to produce value-added products and improve margins of processing.

Current processes for the production of liquid products made from cellulosic material also suffer many drawbacks. For example, often liquid products are extracted from cellulose-containing materials using harsh conditions such as high temperatures in combination with corrosive treatments of acid-chlorite and alkaline treatments, mechanical methods such as high-pressure homogenization, ultrasonication, or ball milling, or require multiple purification techniques (e.g., due to high ash content) for generating small quantities of liquid product. Current extraction methods for cellulose involve multi-step physical, chemical, and physicochemical methods that are time-consuming, volatile, toxic and corrosive.

What is needed, therefore, are more environmentally-friendly methods and systems for extracting liquid products from lignocellulosic (or other) feedstocks in an energy-efficient and clean (i.e., with no harsh chemicals added) manner while emitting no harmful byproducts, such as VOCs. Embodiments of the present disclosure address these needs as well as other needs that will become apparent upon reading the description below in conjunction with the drawings.

### BRIEF SUMMARY OF THE INVENTION

The present disclosure relates generally to chemo-mechanical conditioning processes. Particularly, embodiments of the present disclosure relate to solid and liquid products made by chemo-mechanical cellular explosion processes, and systems and methods of making and using the same. An exemplary embodiment of the present invention can provide a liquid product obtained from biomass material undergoing a chemo-mechanical cellular explosion process. The process can include combining one or more additives with a feedstock to obtain a first mixture, the feedstock comprising a fibrous material and water, the fibrous material comprising lignin. The process can include conditioning the first mixture to obtain a liquid product and a dry pulp product.

In any of the embodiments described herein, a liquid product can be obtained from a biomass material. The liquid product can comprise one or more of water, bio-stimulant compounds, bio-nutrient compounds, minerals, amino acids, nano cellulose, lignin, hemicellulose, tannins, terpenes, polyphenol compounds, primary metabolites or secondary metabolites.

In some embodiments, water can be present in the liquid product in an amount from about 25% to about 99% by weight, based on the total weight of the liquid product. Lignin can be present in the liquid product in an amount from about 0.01% to about 75% by weight, based on the total weight of the liquid product.

In some embodiments, the liquid product can comprise water in an amount of about 50% or greater by weight, based on the total weight of the liquid product.

In some embodiments, the liquid product can comprise water in an amount of about 60% or greater by weight, based on the total weight of the liquid product.

In some embodiments, the liquid product can comprise water in an amount of about 70% or greater by weight, based on the total weight of the liquid product.

In some embodiments, the liquid product can comprise water in an amount of about 75% or greater by weight, based on the total weight of the liquid product.

In some embodiments, lignin can be present in the liquid product in an amount from about 0.1% to about 30% by weight, based on the total weight of dry matter (DM) of the liquid product.

In some embodiments, lignin can be present in the liquid product in an amount from about 1% to about 20% by weight, based on the total weight of dry matter (DM) of the liquid product.

In some embodiments, lignin can be present in the liquid product in an amount from about 6% to about 17% by weight, based on the total weight of dry matter (DM) of the liquid product.

In some embodiments, the liquid product further can comprise proteins and one or more volatile organic compounds (VOCs) or non-volatile organic compounds.

In some embodiments, the liquid product can contain substantially all VOCs present in the biomass material.

In some embodiments, the liquid product further can comprise one or more of catechin, taxifolin, procyanidin, caffeic, p-hydroxybenzoic acid, or ferulic acid.

In some embodiments, the biomass material can be conditioned at a temperature from about 180° F. to about 300° F. prior to obtaining the liquid product.

In some embodiments, the biomass material can be conditioned under a pressure gradient applied to the biomass material such that the liquid product is liberated from the biomass material.

In some embodiments, the minerals can comprise one or more of potassium, phosphorus, nitrogen, calcium, magnesium, sulfur, sodium, iron, manganese, zinc, or copper.

In some embodiments, potassium can be present in the liquid product in an amount from about 0.1% to about 1.5% by weight, based on the total weight of dry matter (DM) of the liquid product.

In some embodiments, phosphorus can be present in the liquid product in an amount from about 1% to about 8% by weight, based on the total weight of dry matter (DM) of the liquid product.

In some embodiments, nitrogen can be present in the liquid product in an amount from about 500 parts per million (ppm) to about 4500 ppm, based on the total weight of liquid sample of the liquid product.

In some embodiments, calcium can be present in the liquid product in an amount from about 0.1% to about 3% by weight, based on the total weight of dry matter (DM) of the liquid product.

In some embodiments, magnesium can be present in the liquid product in an amount from about 0.1% to about 1.2% by weight, based on the total weight of dry matter (DM) of the liquid product.

In some embodiments, sulfur can be present in the liquid product in an amount from about 0.05% to about 1% by weight, based on the total weight of dry matter (DM) of the liquid product.

In some embodiments, sodium can be present in the liquid product in an amount from about 0.05% to about 1% by weight, based on the total weight of dry matter (DM) of the liquid product.

In some embodiments, iron can be present in the liquid product in an amount from about 300 parts per million (ppm) to about 4000 ppm, based on the total weight of dry matter (DM) of the liquid product.

In some embodiments, manganese can be present in the liquid product in an amount from about 150 parts per million (ppm) to about 1500 ppm, based on the total weight of dry matter (DM) of the liquid product.

In some embodiments, zinc can be present in the liquid product in an amount from about 50 parts per million (ppm) to about 4000 ppm, based on the total weight of dry matter (DM) of the liquid product.

In some embodiments, copper can be present in the liquid product in an amount from about 1 parts per million (ppm) to about 100 ppm, based on the total weight of dry matter (DM) of the liquid product.

In some embodiments, the amino acids can comprise one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, or valine.

In some embodiments, the bio-stimulant compounds can comprise one or more of pipenes, camphenes, kaolins, polyacrylamides, humic acids, fulvic acids, or organic acids.

In some embodiments, the bio-stimulant compound can be present in the liquid product in an amount from about 0.01% to about 20% by weight, based on the total weight of dry matter (DM) of the liquid product.

In some embodiments, humic acid can be present in the liquid product in an amount from about 0.001% to about 10% by weight, based on the total weight of dry matter (DM) of the liquid product. Fulvic acid can be present in the liquid product in an amount from about 0.1% to about 20% by weight, based on the total weight of dry matter (DM) of the liquid product.

In some embodiments, the liquid product can have a pH from about 1 to about 7.

In some embodiments, the liquid product can have a pH from about 2 to about 5.

In some embodiments, the liquid product can have a pH from about 4 to about 5.

An exemplary embodiment of the present invention can provide a liquid product obtained from a chemo-mechanical cellular explosion process. The process can include combining one or more additives to a fibrous material, removing a first portion of water from the fibrous material, solubilizing the one or more additives with the first portion of water, weakening cell walls of a plurality of cells of the fibrous material, applying a shear force to the fibrous material to increase a pressure and a temperature of the fibrous material, vaporizing a second portion of water in the fibrous material by fractionating the fibrous material, and exposing the fibrous material to reduced pressure to induce the exploding of the plurality of cells in the fibrous material. The fibrous material can comprise water and lignin.

In some embodiments, the one or more additives during the chemo-mechanical cellular explosion process can comprise the liquid product.

In some embodiments, the liquid product can decrease a surface contact angle when the liquid product is applied to a surface.

An exemplary embodiment of the present invention can provide a method of promoting growth in a plant by administering the liquid product to the plant.

An exemplary embodiment of the present invention can provide a method of reducing pathogen survival in a plant by administering the liquid product to the plant.

An exemplary embodiment of the present invention can provide a method of reducing insect engagement with a plant by administering the liquid product to the plant.

An exemplary embodiment of the present invention can provide a method of reducing lost circulation or cracking at a drilling site by administering the liquid product to the drilling site.

An exemplary embodiment of the present invention can provide a method of synthesizing nanometals by contacting the liquid product to a solution comprising one or more metal ions.

An exemplary embodiment of the present invention can provide a method of forming nanocellulose by wet-grinding the liquid product.

An exemplary embodiment of the present invention can provide a method of forming nanocellulose by freeze-drying the liquid product.

An exemplary embodiment of the present invention can provide a method of forming nanocellulose by applying shear forces to the liquid product.

An exemplary embodiment of the present invention can provide a liquid product obtained from a biomass material, wherein the biomass material is sheared in a hydrodynamic cavitation reactor.

In some embodiments, hydrodynamic cavitation reactor can generate and collapse bubbles in the biomass material to solubilize into the liquid product one or more of bio-stimulant compounds, bio-nutrient compounds, minerals, amino acids, nano cellulose, lignin, hemicellulose, tannins, terpenes, polyphenol compounds, primary metabolites or secondary metabolites.

In some embodiments, water can be present in the liquid product in an amount from about 25% to about 99% by weight, based on the total weight of the liquid product. Lignin can be present in the liquid product in an amount from about 0.01% to about 75% by weight, based on the total weight of the liquid product.

An exemplary embodiment of the present invention can provide a liquid product obtained from a fibrous material in a chemo-mechanical cellular explosion process. The process can include feeding the fibrous material into a chamber, applying a shear force to the fibrous material by rotating the shaft, and inducing a cellular explosion in a plurality of cells of the fibrous material to generate a liquid extract and a fibrous pulp. Heat from an external source is not injected into the chamber when the shear force is applied. The chamber can comprise a shaft having one or more threads disposed circumferentially around the shaft. Applying the shear force to the fibrous material can increase a pressure and temperature of the fibrous material.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 illustrates an exemplary process according to some embodiments of the present disclosure.

FIG. 2 illustrates a traditional process for processing fibrous material for comparison with processes of the present disclosure.

FIG. 3A illustrates an exemplary conditioning process according to some embodiments of the present disclosure.

FIG. 3B illustrates an exemplary conditioning process according to some embodiments of the present disclosure.

FIG. 4A is a photograph of a fibrous pellet produced from a conventional process.

FIG. 4B is a photograph of a fibrous pellet produced from a process according to some embodiments of the present disclosure.

FIG. 5A is a scanning electron microscope (SEM) image of a fibrous pellet produced from a conventional process.

FIG. 5B is a SEM image of a fibrous pellet produced by a process according to some embodiments of the present disclosure.

FIG. 6 illustrates a machine used for some processes according to some embodiments of the present disclosure.

FIGS. 7A through 7N are TEM images of a liquid product produced from a process according to some embodiments of the present disclosure.

FIG. 8 is a survey X-ray photoelectron spectrum (XPS) of liquid product produced from a process according to some embodiments of the present disclosure.

### DETAILED DESCRIPTION

Disclosed herein is a comprehensive solution for a compressive explosion-based process that concurrently dewaters, dries, fractionates, extracts and separates cell-based (biological) materials and particularly those that (a) are viewed as recalcitrant in terms of their reluctance to be industrially processed and (b) have liquid co-products that have market value. The presently disclosed technology can be agnostic to the state of the biological material; it can be either living or dead. For example, in addition to processing agricultural residues, woody and herbaceous energy crops, and green lignocellulosic feedstock, the presently disclosed technology can apply very well to processing spent materials, such as coffee grains, wastepaper, woody construction waste, poultry litter, poultry residuals such as feathers, bio-solids, compost production, and the like.

The liquid product can be obtained from a chemo-mechanical cellular explosion process as described herein. Alternatively, or in addition thereto, the liquid product can be provided from or obtained by a third party. The chemo-mechanical cellular explosion process can include shearing and expelling-based mechanisms using dry, high-molecular weight, and non-foaming additives or surfactants.

In some embodiments, chemo-mechanical cellular explosion process can include a hydrodynamic cavitation reactor for shearing and expelling-based process to extract the liquid product from biomass material at low temperatures. In general, the biomass material can be added to a hydrodynamic cavitation reactor, as described in more detail herein. In some examples, the liquid product collected can be added back or recycled into the process as a process aid. Alternatively, the additive can be a non-foaming surfactant and can be applied in a dry powder form to be solubilized in-situ when moisture is liberated from the biomass materials or can be added as a liquid. The process aid or additive can act as a lubricant that manages the frictional heating generated by the attrition of the biomass material during shearing. The additive can also be an emulsifying agent to maintain effective expelling rates of the biomass material constituencies during expelling. During the shearing process, the additive can be scissored by the attritional and/or pressure forces into smaller and lower molecular weight additive, thereby permitting effective penetration into the biomass materials. Additionally, the process aid or another additive can be mixed with the biomass material to remove ash within the biomass materials.

In some embodiments, during the chemo-mechanical cellular explosion process, the biomass material releases an intermediate fluid extract. The intermediate fluid extract can function as a surfactant to further weaken the cell walls of the cells of the biomass material such that an additive is not needed. The intermediate fluid, like the additive, can be an emulsifying agent that maintains effective expelling rates of the biomass material constituencies during expelling. Further, the intermediate fluid can be scissored by the pressure and/or temperature and can permit effective penetration into the biomass materials. In some instances, the intermediate fluid can act as a chelator to bind to metal ions within the biomass material and solubilize such metal ions into the liquid product at the end of the chemo-mechanical cellular explosion process.

In some embodiments, penetration of scissored additive can cause rotational shearing forces within and around the biomass material and form hydrodynamic cavitation to induce high pressures in proximity to the biomass materials. Flow-through hydrodynamic cavitation can utilize energy released upon the implosion of cavitation bubbles to thoroughly mix components within the biomass material (e.g., lignin, hemicellulose, etc.) with water and increase the contact surface area of the materials. Such hydrodynamic cavitation increases solubility of components (e.g., bio-stimulant compounds, bio-nutrient compounds, minerals, amino acids, nano cellulose, lignin, hemicellulose, tannins, terpenes, polyphenol compounds, primary metabolites and secondary metabolites) of the biomass material into the liquid product.

The hydrodynamic cavitation can significantly lower the level of impurities in the liquid product extracted from the biomass material, allowing for express, high-efficient extraction of liquid product from a variety of biomass materials. Although extreme conditions can be disadvantageous, the outcome of an optimized controlled hydrodynamic cavitation treatment can be beneficial. The extracted liquid products can vary in appearance and volume, depending on the temperature, additive, initial levels of components within the biomass material, the water-to-biomass material ratio, the inlet pressure of the screw press, the rate of shearing and expelling, the separation procedure and other conditions.

The liquid product can be rich in tannins, terpenes, and polyphenol compounds that provide antimicrobial, antioxidant and/or insecticide properties. The liquid product can also comprise bio-stimulant and bio-nutrient compounds that assists in crop and plant health and promotes growth. The liquid product can also be rich in organic acids to help plant roots receive water and nutrients. The liquid product can also contain minerals such as potassium, phosphor, phosphorus, nitrogen, calcium, magnesium, sulfur, sulfurous, sodium, iron, manganese, zinc, and copper. The liquid product can also comprise amino acids and proteins. The liquid product can also be rich in cellulose, lignin, and hemicellulose in micro and nanostructures.

By way of example, the liquid product extracted from coniferous biomass materials, such as plants belonging to the Taxus, Cupressus, Picea, Pinus, Cedrus, Araucaria genera, can contain a variety of phytochemicals including terpenoids (e.g. resin acids, monoterpenes, sesquiterpenes, and diterpenes), alkaloids (e.g., piperidines), and polyphenols (e.g., phenolic acids, flavonoids, proanthocyanidins, lignans, acetophenones, and stilbenes). Liquid product containing phytochemicals from coniferous plants can provide antioxidant properties, anti-inflammatory properties, antimicrobial properties and in some cases, anticancer properties and antidiabetic properties. For instance, catechin, taxifolin, procyanidins, caffeic, p-hydroxybenzoic acid, and ferulic acid extracted from the bark of Pinus pinaster of the Pinus genus has been used in the antioxidant drug, Pycnogenol.

By way of another example, the liquid product extracted from orchard grass, when applied to a test lawn, removed the dandelions and rapidly grew the grass. This result would enable a municipality or lawn service to process the cut grass and then reapply the extract back on the lawn. The water savings as well as the avoidance of harsh fertilizers would have broad appeal. The grass extract has additional potential also. In another test, the orchard grass extracts were processed by heating. The proteins coagulated, thereby making this process suitable for the much-pursued leaf protein concentrate applications and a very viable alternative to the Pro-Xan process. Such advancements can greatly expand the design space of, for example, the “meatless protein” market.

The presently disclosed technology not only concurrently dewaters, dries, fractionates, extracts and separates plant material, but it also fundamentally transforms the resulting fiber with the plant cells completely exposed. All this renders the material ready for the follow-up processing for many industry applications such as bioenergy feedstock, advanced materials production, absorbents manufacture, soil amendments, water filtration systems, strengthening agents for the construction industry, inputs for Biopharma, fungus and yeast substrates, and many more, some examples of which will be outlined below.

The presently disclosed liquid product can be added to wood fiber to condition the wood fiber such that it is optimized for inputs for very advanced lignocellulosic chemistries, such as xylo-chemistries as well as solid material developments. The tremendous reduction in particle size allows for quicker conversion. Many products are now feasible, most notably carbonized products such as graphene and the like. In terms of graphene, such a process can enable lower-cost production of graphene, allowing it to be added to fabrics for better aesthetics and performance, such as in terms of moisture wicking and pest barriers (e.g., mosquitoes.) Graphene is also perfectly suited as an input for degradable electronics, renewable carbon materials for electrochemical energy storage, and circuit substrates, thereby replacing millions of tons of hazardous material placed in landfills around the world every year.

The agriculture and horticulture industries utilize fungi for many plant health benefits to their hosts, such as conferring improved growth, disease resistance, and abiotic stress tolerance. To that end, the liquid product produced by processes of the present disclosure can serve as a liquid substrate to mass-produce fungi. For instance, the liquid product can be added to the substrate (e.g., straw, logs, grains, coffee granules, and other materials) prior to fungal growth such that the fungi collects food from remnants of the liquid product in the respective substrate. Alternatively, or in addition thereto, the substrate that fungus is mass-produced on can be soaked in liquid product during fungal growth. In yet another embodiment, mass-produced fungi can be grown in a liquid medium made up of the liquid product. The range of fungi species' postulated is extensive, but the liquid product can heighten colony-forming unit rates when added to any substrate and/or serving as a liquid medium for fungal growth, as a particular example, for Trichoderma species. Such derivative enzymes have broad applications in additional markets such as biofuels, food products, cleaning supplies, and others, as described in more detail below.

Additionally, advanced processes are being developed that utilize organic phenol-based chemistries such as humic acid to serve as building blocks for advanced materials used in green energy systems such as supercapacitors. The liquid extract produced by processes of the present disclosure can be rich in humic and fulvic acids, as well as other organic acids.

The environmental challenges imposed by an oversupply of plastics in the world necessitate solutions for recycling. By utilizing products of the present disclosure, less plastic can be used. Such materials are often referred to as wood-plastic composites. In combination with products of the present disclosure, better cross-linking can occur with a plastic feedstock. This improved effect can enable improved consumer goods, such as composite decking. Moreover, the products disclosed herein provide a small particle size necessary to simulate the appearance of real wood and achieve improve material properties.

Research is also advancing that produces sustainable polymers made from carboxylic acid that prevents misting of jet fuel in the event of crash. Certain products of the present disclosure are rich in organic carboxylic acids.

3D printing is now mainstream, but the preponderance of materials utilized is largely synthetic. Products of the present disclosure can be used as a filament for 3D printing, due to improved form-factor and small particle size.

Cellulose nanocrystals or “nanocellulose” are unique nanomaterials derived from the most abundant and almost inexhaustible natural polymer: cellulose. Due to the various hydroxyl groups and strong hydrogen bonding networks, cellulosic material has wide and exciting potential in many industries. Despite the properties, cellulose fibrils tend to aggregate and form bulk structures having both stiff regions (e.g., ordered crystalline structures) and flexible regions (disordered, amorphous regions) that must be broken down to form nanocrystalline or nanofibrillated cellulose. The exposed cellulose, once viewed as cost-prohibitive to obtain from trees and the like, can now be converted into nanocrystals or nanofibrils, including hairy cellulose nanocrystalloids, for use in medical, material sciences, and electronics using the process described herein.

The liquid product generated from the chemo-mechanical cellular explosion process can include highly intact lignin-containing nanocellulose materials in one or both nanocrystalline cellulose and/or nanofibrillated cellulose types. The presently disclosed technology can condition the wood fiber by consolidating the lignin into exposed “drops” on the cellulose surface, which consequently lays the cellulose barer. Importantly, such process maintains the wood fiber at low temperatures such that the lignin-containing nanocellulose material is not exposed to high temperatures. Additionally, the conditioning of the wood fiber maintains a certain level of moisture (e.g. is never dried) and therefore can further prevent degradation of the lignin-containing nanocellulosic materials. This process then can allow developing industrial processes to produce nanocellulose by removing the lignin in more-cost effective and more environmentally friendly way. The lignin-containing nanocellulosic material can be processed further by wet-grinding, microfluidization, freeze-drying, ball milling, and other suitable techniques to produce nanocellulose.

Nanocellulose generated from the described process can produce and/or be applied to various applications, including without limitation, nanocomposite materials, surface modified materials, transparent paper with special functions, a thickener in cosmetics, a texturing agent in food, filler of special textiles, biodegradable packaging, CO₂ adsorbent, oil recovery, wound dressing, skin grafting, drug delivery, implant for soft tissue, and blood vessel replacements. In some embodiments, the liquid product has beneficial emulsifying characteristics, such that the liquid product can be an effective wetting agent when applied to modify a surface of a material. For instance, when applying the liquid extract as a pesticide, the liquid product will increase the coverage of the plant's surface due to the ability of the liquid to spread more efficiently on the surface. Wettability, or ability to spread over a surface, is measured by the contact angle of a droplet. A lower contact angle (e.g., less than 90°) signifies greater wettability, whereas higher contact area (e.g., greater than) 90° signifies lower wettability. In some examples, the liquid product may decrease the contact angle to less than 90° when applied to a surface (e.g., less than about 85°, less than about 80°, less than about 75°, less than about 70°, less than about 65°, less than about 60°, less than about 55°, less than about 50°, less than about 45°, less than about 40°, less than about 35°, less than about 30°, less than about 25°, less than about 20°, less than about 15°, less than about 10°, less than about 5°, less than about 2°, and any range in between, for example, less than about 17.3°).

The liquid product generated from the chemo-mechanical cellular explosion process can be concentrated through a variety of filtration methods such as gravity, vacuum filtration, membrane nano-filtration, ultra-filtration and the like.

Processes and products of the present disclosure can serve as feedstock to allow for the production of sustainable polymers from fragrant molecules often contained in aromatic species such as pine, witch hazel, Eucalyptus, and the like. Given the struggles evidenced in the world today from polymers and plastics produced by conventional petroleum feedstocks, such processes of the present disclosure can provide an improvement in polymer production.

Recent advances in electrochemistry have occurred that simplify the creation of valuable and coveted molecules that are used for drugs, electronics, and the like. Processes of the present disclosure can generate important reactive intermediate molecules known as a carbocation needed for ether synthesis from inexpensive carboxylic acids. Products of the presently disclosed technology is rich in carboxylic acids, thereby providing even less-expensive feedstocks for this critical process.

The unique and cost-effective manner in which raw, green lignocellulosic feedstock can be conditioned according to the technology of the present disclosure makes available many applications in horticulture. These applications range from replacing non-sustainable growing substrates such as peat and other nonrecyclables, to producing very effective and organic soil amendments to applying the liquid extract as organic fertilizers.

Typical greenhouse substrates consist of peat and perlite. Peat is a hydrocarbon and non-renewable. Processes of the present disclosure can produce a wood feedstock in a form-factor conducive to growing mediums. A portion of products from the present technology can be substituted for a portion of the peat, thus reducing the dependence on hydrocarbons. Additionally, products of the present disclosure can inherently serve as an inoculated mushroom growing media. Due to its expanded form-factor, the products can also compress into a growing and erosion control mats and does so at significantly reduced cost.

Hydro mulch is a mix of fiber/grass seed/fertilizer that is applied to steep inclines where erosion could occur. Presently, mechanically treated wood fiber is used as a base material. In contrast, products of the present disclosure can offer a superior product produced with substantially less energy and emissions at a much lower price. The consequence of this is less top soil erosion and cleaner waterways. Hydroseeding is a mixture of grass seed, fertilizer and wood fiber. Products of the present disclosure can provide greater moisture absorbency, thus helping to accelerate seed germination.

Demand for natural and organic food is rapidly increasing. Conversely, continuous farming drains the soil of its vitality. Due to its nature produced by organic acids, sugars, humic/fulvic acids and a very diverse amount of amino acids, products of the present disclosure can create a soil environment that attracts the necessary microbial activity that is vital for the fixation of nitrogen and other nutrients in the soil. In particular, the liquid product generated from the chemo-mechanical cellular explosion process can include bio-nutrient and/or bio-stimulant components, such as, for example, humic substances, complex organic materials (e.g., pipenes or camphenes), beneficial chemical elements (e.g., Al, Co, Na, Se, and Si), inorganic salts (e.g., phosphite), chitin and chitosan derivatives, antitranspirants (e.g., kaolin and polyacrylamide), free amino acids (e.g, amino acids comprise one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine), and nitrogen-containing substances (e.g., proteins, peptides, polyamines, or betaines) that can be added directly into the soil environment. In some instances, liquid product can include both non-microbial and microbial plant bio-stimulants (e.g, nitrogen-fixing Rhizobium, Azotobacter spp., Azospirillum spp., Pseudomonas spp., and Bacillus spp.). Such liquid product fertilization may improve seeding germination, enhance flowering, plant and/or crop growth, fruit setting, crop productivity, and nutrient use efficiency. In some instances, addition of the liquid product into the soil may induce resistance to pests and pathogens to act as a pesticide. Alternatively, or in addition thereto, the presently disclosed technology can allow for the extraction of micronutrients, nanofertilizers, and primary and secondary metabolites found in crop plants (e.g., tomato plants) and woody materials. Extraction of these constituents that contain endophytes can generate a liquid product that has an elixir effect to enrich the soil and/or strengthen plants or crops to make them more resistant to stress such as cold weather. For instance, use of the liquid product on a seasonal plant may allow for longer blooms even when the seasons begin to change.

In some examples, the presently disclosed technology can allow for the extraction of bio-stimulants found in willows and other water-laden feedstocks that were once considered ineffective for processing due to the cost associated. In other examples, the extraction of bio-stimulants found in non-wood biomass feedstocks such as oil palm trunk, corn sorghum, sorghum, sunflower, bamboo, or silver grass.

Additionally, the characteristics of products of the present disclosure can provide for very specialized gene expression and controls once considered not possible by organics. The unadulterated nature and quantities of contained organic chemicals such as the various glutamine concentrations found in different species provides for very powerful horticultural methodologies. For example, a liquid extract produced from processes of the present disclosure utilizing hardwood species can be used as a cloning agent for pecans. Pecan trees can be started from seed or cloned from stems of live trees. The process of cloning presents challenges in the survival of the clone. The quicker that the clone is able to add healthy roots, the chances of its survival increase dramatically. The numerous organic acids found in products of the present disclosure are the building blocks for producing growth hormones that stimulate healthy and rapid root growth.

In another example, for certain species of feedstocks and particularly for that of the bark components, the presently disclosed technology can extract a considerable amount of tannin. Research is proving that remarkable changes in soluble nitrogen manifests in soils after regular applications of tannin and related phenolic compounds. These tannins are utilized by soil microorganisms as substrates, thereby increasing microbial demand for nitrogen and immobilization in microbial biomass. This increase translates to more nitrogen is being fixed by the microbes, making more nitrogen available to plants.

Products of the present disclosure can also offer pest control and defensive mechanisms to the horticultural markets once considered the monopolized domains of synthetic chemicals. Allelopathic effects made possible by products disclosed herein can serve as an example: the liquid extracts can enable new but sustainable approaches to weed control. The liquid extracts from hardwood can be very effective for nematode control also, which is imperative to preserve millions of dollars in produce. Various combinations of phenols and over-applications of other bio-stimulants and amino acids are very effective growth control options to that of synthetic chemicals.

The presently disclosed technology, such as fiber and liquid extracts produced from it, offers the construction markets inputs never available. The availability of the fiber can catalyze the development of newly engineered lumber, concrete, and asphalt formulations, resins, and preservatives.

In some instances, the wood fiber and liquid extracts of the disclosed technology can be used in drilling applications such as surfactants to prevent lost circulation and/or cracking by reducing viscosity and anticorrosive properties. Current surfactants and loss circulation materials are cost-prohibitive and tend to perform inconsistently between batches. Use of the wood fiber and liquid extracts can provide green solutions for high-volume use as lost circulation material and surfactant solutions. In addition, interfacial properties of the liquid products of the disclosed technology can assist in reducing viscosity and corrosion during drilling while enhancing the lost circulation materials and reduce cost of drilling.

Wood fiber is a very good sound insulator. Such products are popular in Europe and are gaining ground here in the United States. Products of the present disclosure can provide even better insulation, due to improved densification of the smaller particle sizes. Such products of the present disclosure can also enable improved fiber-based or particle-based boards such as Medium Density Fiber (MDF). For such applications as fiber cement siding, the expanded format of the products disclosed herein can provide additional support to concrete based siding. The presently disclosed technology also allows the use of alternative board material such as giant reed and the like, thereby improving the carbon cycling for the environment. The format of the products of the present disclosure can also allow for less binder to be utilized in the board construction, thereby granting another environmental advantage.

Products of the present disclosure can also be used in the advancement of engineering boards and siding. Lignin is a major component of wood fiber and is composed of various phenol groups. Using the phenol groups contained in the extract, sustainable foam boards may now be constructed. This is made possible by the ability of the present technology to produce a portion of the lignin contained in the wood fiber as solubilized in a liquid extract. These extracted phenols can then be utilized in the formulation of foam boards.

Products disclosed herein can also help to reinforce concrete. In order for concrete to support high loading, it must be reinforced. Typically, rebar steel is used to reinforce concrete. The products of the present disclosure can be a very good reinforcement mechanism for concrete.

The technology disclosed herein can be used to make engineered bamboo articles, such as flooring. Before bamboo can be converted into value added products, it has to be broken down. The processes of the present disclosure can allow for the bamboo fiber to be broken down into a material that can easily be converted to valuable products such as bamboo composite boards and bamboo flooring.

The technology disclosed herein can allow for the partial removal of lignin from lignocellulosic fiber. This lignin can be collected in a liquid extract. From this extract, the lignin and other components can be isolated and then utilized as a component for natural asphalt. In some embodiments, the components can be isolated by general post-processing methods such as, for example, cloud-point extraction, micellar-mediated isolation, and the like. Cloud-point extraction is a technique in which extraction of organic and/or inorganic compounds from a liquid product is done using benign extractants like non-ionic surfactants and heating to a critical temperature such that the compounds are separated out from the bulk solution. Cloud-point extraction can be used to extract temperature sensitive bioactive components from the liquid product, such as organic and inorganic components. These extraction methods can pull out various compounds from the liquid product and can be tuned based on the surfactant type, structure of compounds present, electrolyte characteristics or concentration, solvent nature, temperature, and/or pH of the solution. Cloud-point extraction or micellar-mediated isolation can be more rapid and rely on benign and non-toxic surfactants compared to conventional solvent extraction.

Certain species of wood such as teak, red oak, and the like produce liquid extracts via the presently disclosed technology that can act as natural wood preservative. Such processes are generally expressed as acetylation. Acetic acid contained in the extract can create an environment where mold cannot grow. Once considered not scalable to a sufficient and cost-effective industry magnitude, the presently disclosed technology can make acetylation possible.

The presently disclosed technology can contribute significantly to environmental and remediation markets. Products of the present disclosure can create various adsorbents and filter medias, as well as accelerate the composting of biosolids. Adsorbents are utilized in nearly every industrial application, where spills can be a problem. The products disclosed herein can show much higher absorbency rates than commonly used material such as clay or sawdust.

Synthesis of nanomaterials of various sizes depend on several properties, one being the degree of supersaturation and hydrodynamic conditions when the nanomaterials are undergoing nucleation and growth. As would be appreciated by one of skill in the art, particle size of such nanomaterials varies with varying supersaturation. Certain aspects of the disclosed technology can enable synthesis of nanometals using green and lost-cost methods. In particular, the liquid product may effectively reduce transition metal salts and allow for high-rate separation of water and bio-actives to enable synthesis of various metal nanoparticles with conditions such as low temperatures, low pressure, fast reaction time, and/or easy-to-handle pH. Resulting metal nanoparticles can have uniform structures and sizes due to the increased nucleation and stabilization of nanoparticles from the liquid product. Nanomaterials produced from the methods described herein can be useful for technology and industry sectors including information technology, homeland security, medicine, transportation, energy, food safety, or environmental science. Mixing the liquid product with one or more transition or alkali metal salts such as, for example, oxides, nitrates, sulfates, phosphates, chlorides, or carbonates of various metals (e.g., iron, copper, nickel, titanium, silver, gold, platinum, and the like) can generate inorganic nanoparticles. For instance, mixing liquid product with calcium chloride salt can result in calcium oxide nanoparticles. As another example, mixing liquid product with iron nitrate can result in iron oxide nanoparticles. Such nanometals formed from methods using the liquid product can be used to make lower-cost semiconductor materials and inorganic catalysts for production of biofuel.

Nanomaterials produced using the liquid extract can have average have particle sizes (e.g., average particle diameter) ranging from about 1 nm to about 500 nm (e.g., from 5 nm to 450 nm, from 20 nm to 400 nm, from 25 nm to 350 nm, from 30 nm to 300 nm, from 50 nm to 250 nm, from 75 nm to 200 nm, from 100 nm to 150 nm, or from 125 nm to 150 nm).

Filtration is a part of many industrial processes. Wood fiber is used in many applications. Filtration effectiveness has a direct correlation to the surface area of the filter media. Products of the present technology can provide significantly greater surface area than typical machined wood fiber. The processes disclosed herein can also be very scalable thereby allowing large issues to be addressed, such as the control of red-tide and algae issues caused by fertilizer run-off.

Bio-solids are becoming a very large problem in the world. Disposal via land applications is now proving to be a less-than-optimal mechanism due to metals and other materials contained. Composting is quickly becoming the preferred approach to disposal. The products produced by the present technology can contain sugars and other molecules that rapidly accelerate the growth of necessary bacteria needed. Subsequently, the metabolites of these bacteria build upon the already-rich nutrient concentration contained in the composted bio-solids.

Additionally, the products produced by the present disclosed technology can be rich in amino acids that are proving to be very valuable phytopharmaceutical inputs to combat cancer and other diseases. Diethyl ether extracts and alkaloids can make possible anticancer medications for the treatment of breast cancer and dysfunctional maladies to human health. Additionally, it has been found that quantitative reductions in short-chain fatty acids, especially butyrate, contribute to the progression of chronic kidney disease and gastrological issues. The products disclosed herein can be rich in such short-chain fatty acids when fermented and processed. The products can also contain berberine depending on feedstock species, which assists the lowering of sugar and leads to a maintenance of healthy cholesterol levels; this serves as a powerful tool for the treatment of diabetes.

The liquid product with a high concentration of amino acid constituents can be utilized in emissions capture solutions by capturing carbon dioxide (CO₂) via chemical absorption or adsorption. The primary mechanism involves the reaction between CO₂ and the amino acid functional groups, such as amino (—NH₂) and carboxyl (—COOH) groups. When CO₂ comes into contact with an amino acid, it reacts with the amino and/or carboxyl groups to form a carbamate molecule. This reaction is reversible, such that carbamate can release CO₂ when conditions change, such as changes in temperature or pressure. Emissions capture using the liquid product can also include using the liquid product to create catalysts or reactive agents as described in more detail herein.

In one example, the liquid product can serve as green precursors for synthesizing metal organic frameworks (MOFs) for emissions capture. The liquid extract offers several advantages over traditional chemical synthesis methods, such as being environmentally friendly, cost-effective, and scalable. The extract contains a variety of organic molecules, such as polyphenols, flavonoids, and terpenes, that can act as reducing agents, stabilizers, or templates for synthesizing MOFs. These organic molecules can react with metal ions to form stable complexes, which can then be converted into metal oxide frameworks through a calcination process.

In another example, the nanoparticles contained in the liquid product and the ability of the liquid product to green-synthesize nanometals, makes available nanoparticle-assisted spray absorption (NASA)-based technology for the use of air emissions capture. This application involves mixing the liquid product's nanoparticles and nanometals to a water spray or another fluid suitable for spraying. The mixed spray is then directed at the emission source and the pollutants in the air are absorbed into the liquid droplets. The addition of nanoparticles to the liquid spray enhances the absorption efficiency by increasing the surface area of the liquid droplets. Since nanoparticles have a high surface area-to-volume ratio, the nanoparticles within the liquid spray droplet can significantly increase the surface area of the liquid droplets. This increased surface area allows for more efficient contact between the liquid droplets and the pollutants in the air.

Nanoparticles can also assist with the absorption of pollutants by acting as catalysts or reactive agents. Some nanoparticles, such as titanium dioxide, zinc oxide, ferric oxide, copper sulfide, and cadmium sulfide have the ability to react with the pollutants and facilitate their conversion or destruction. For example, some metal nanoparticles can catalyze the oxidation of VOCs in the presence of oxygen, leading to the formation of carbon dioxide and water. NASA has been shown to be effective for the capture of a wide range of pollutants and greenhouse gases, including VOCs, nitrogen oxides (NOx), and sulfur oxides (SOx).

Various plant-based and non-plant-based feedstocks can be extracted for specific medicinal purposes. The present technology can be very effective in hemp and Cannabis processing. The liquid extracts render valuable cannabinoids and other nutraceuticals that offer new treatments. Various antibacterial, antioxidant, and anti-inflammation properties of flavonoids are also made possible by the liquid product described herein. In some examples, the presently disclosed liquid product can serve as a complete or partial therapeutic or curative formulation for Huanglongbing disease, commonly referred to as citrus greening.

The present technology can contribute significantly to human health applications. Various components of the products of the present disclosure can be used to produce insecticides and pesticides from such obstinate and exotic feedstock as oak and bloodroot. The technology also makes possible very low-cost products for aromatherapy and other terpenes for engineered aroma inputs to Cannabis and specialized/engineered wines.

Experimentation is also underway to use the present technology for the production of insoluble dietary fiber and its inclusion as a food additive. Numerous studies have revealed increased physiological and psychological improvements when good bacteria utilize this type of insoluble fiber as substrates during their gastrological migration through the body.

Aside from the gastrological benefits, the short- and medium-chain fatty acids made available via products of the present disclosure can exhibit antimicrobial activity for oral microorganisms. This type of treatment will contribute to the prevention of tooth and gum diseases.

Mold and mildew have been a growing problem with residential housing for decades. Harsh chemicals and sprays are the conventional approach to eradicating the issue. However, by using the presently disclosed products produced from hardwoods other phenol-rich feedstocks, the present technology can enable an organic mold control mechanism for mold-infested basements and the like.

The presently disclosed technology can have immediate and direct applications to agricultural markets. The disclosed products can enhance litter and bedding applications, as well as improve animal health when added to feed and drinking water. The disclosed products can also have direct applications to the prevention and the treatment of certain animal disease and illness. Additionally, the present technology can also contribute to forestry and thereby participate in a circular economy when applied to wood fiber that is specifically farmed.

The products disclosed herein, such as fibrous materials, due to having very large surface area, can create animal bedding that is extremely adsorbent. This attribute allows harmful moisture and degassing (e.g., ammonia) to be managed. The products can also be very effective for use in drying and warming certain species of livestock. For example, when pigs are born, they are covered in moisture and their skin sensitivities are often high. By applying such fibrous materials to the pigs' skin after birth, the moisture can be rapidly wicked and the skin dried thereby allowing their body temperature to rise more quickly.

The large surface area can also allow bio-char to be produced more efficiently than conventional methods today. Bio-char is also a very effective adsorbent and particularly in sequestering ammonia. Blending biochar with products of the present disclosure can serve as a healthier environment for livestock, and particularly poultry where moisture and ammonia are problematic.

In terms of animal feed, the present technology can contribute to the growth and care of many species and including fish. The organic acids in products of the present disclosure can to serve as an alternative to antibiotics. Studies indicate that pigs fed with a diet inclusive of organic acids show improved average daily feed consumption and average daily weight gain. Some products of the present disclosure can contain tryptophan and a substrate of very small particle-sized fibers that have a form-factor similar to a digestate. Tryptophan is an essential amino acid in swine diets that is important for stimulating feed intake and subsequently, growth performance. Monogastric organisms such as pigs do not produce tryptophan, so it must be included as part of their dietary supplement.

Products of the present disclosure can also serve as a very effective substrate for various yeasts, such as Candida utilis, that create proteins. These proteins have potential for fish feed alternatives. Additionally, for some exotic fish species that have ruminant-like digestive systems, the exposed cellulose exhibited in products of the present disclosure can be more quickly digested as a food source. Lastly, feedstocks such as seaweed and other high-protein herbaceous feedstocks can be processed by the present technology for alternative, plant-based proteins as well. Substituting plant-based proteins for conventional fishmeal returns significant environmental dividends.

For ruminants such as cattle, sheep, and goats, the present technology can offer a number of advantages. Ruminant digestive systems have the potential to digest lignocellulosic materials if the contained lignin is conditioned sufficiently to expose the cellulose. The presently disclosed technology can aggregate the lignin into “droplet” forms, therefore rendering the cellulose more accessible to the cellulases in the animal gut and thereby improving digestion and nourishment. Certain species of wood (e.g., larch) are also proven to boost cattle liver health, being that they are high in arabinogalactans, lignin, flavonoids, and diterpenes. Making available these types of feedstocks to ruminants, particularly those feedstocks once viewed as too recalcitrant would make a world-wide impact relative to human nutrition and well-being.

Certain sizes and specifically engineered form-factors of lignocellulosic fiber can enable a targeted activation of organic acids such as butyrate-2 that consequently produces specific microbiota in the animal gut. The ability of the present technology to process different fiber form-factors, for different species, is critical to the commercialization of this process. Beneficial modulation of the gut microbiome is also “butterflied” into numerous metabolic changes and interdependent pathways that produce short chain fatty acids. These types of prebiotic products are vital for the livestock industry to meet the demand for natural food products.

The liquid product generated from the chemo-mechanical cellular explosion process can also promote antimicrobial and antioxidant effects against agricultural related pathogens. For example, the liquid product may contain tannins, terpenes, and/or polyphenols. As would be appreciated by one of skill in the relevant art, the composition and the content of tannins, terpenes, and/or polyphenols in the liquid product will vary due to the differences in species, types, and sources of feedstock the liquid product is extracted from.

Terpenes, such as monoterpenes, sesquiterpenes, diterpenes, and/or triterpenes can be identified in the liquid product described herein. In addition, the terpenes can present medicinal benefits ranging from properties like anticancer (Cannabis), antimicrobial (e.g., linalool, oryzalexin A, phytocassane A, α-pinene, α-cedrene, aromadendrene, β-caryophyllene, and limonene, neryl acetate, 2-methylcyclohexyl pentanoate, 2-methylcyclohexyl octanoate, and geranyl acetate), antibacterial (e.g., carvacrol, thymol, and fenchol) antifungal treatment (e.g., citral), and insect repellent (e.g., limonene, beta-ionon, geraniol, eugenol, myrcene, α-pinene, and 4,8-dimethyl-1,3,7-nonatriene).

The liquid product of the disclosed technology can provide microbial and antibacterial properties. In particular, the liquid extract can simultaneously act as an antimicrobial agent for various agricultural-related pathogens and bio-nutrient for crops and seedlings. In some examples, use of the liquid product as an antimicrobial and/or antioxidant agent may replace some or all of the use of pesticides on crops. In addition, use of the liquid products for nutrition may limit or end the nitrification of waterways due to higher nutrition being provided below-ground by the liquid product.

The presently disclosed technology can benefit poultry also. Recent consumers are shying away from poultry that are fed antibiotics. As antibiotics do improve the health and survivability of poultry, a possibility exists that traces of these antibiotics remain in the bird after slaughter. Tannins, due to their antimicrobial nature as well as fatty acids, have been proven to combat the growth of pathogens in poultry rearing. Products disclosed herein, such as a liquid extract, can contain and create the valuable fatty acids and tannins. As such, products of the present disclosure can be included in poultry feed and water systems to improve bird health without the addition of synthetic antibiotics.

In a recent finding, the butyric acid produced by the fermentation of certain products of the present disclosure when combined with zine has proven to reduce the occurrence of wood breast in commercial broilers. Woody breast describes a quality issue stemming from a muscle abnormality in a small percentage of chicken meat in the United States. Although this does not pose a health risk to consumers, it causes the meat to be deemed undesirable.

The present technology can also have applications in agroforestry, commonly referred to as tree farming. Agroforestry is a type of agriculture that involves the planting, care, and sustainment of trees or other woody plants. Being that the products of the present disclosure can be originally derived from the xylem and phloem of a tree, once extracted and processed, they can provide a formulation of nutrients and care products for this industry. Prior to the present technology, the liquids in trees were evaporated off the fiber and converted to volatile organic compounds that created emission control challenges.

The presently disclosed technology can contribute directly to production of sustainable and clean energy. Applications can range from biofuels and bio-refineries, wood pellets, and even hydraulic fracturing industries for conventional fuels.

The present technology can utilize green (wet) feedstock to produce a conditioned and fractionated fiber that directly creates a highly-durable, low-moisture, and high-energy wood pellet. It can do so without the use of conventional sizing machinery such as hammer mills and without the need for enormously expensive indirect drying systems. The avoidance of these systems and their consequent capital and recurring costs offers the wood pellet industry a transformative paradigm shift; one that will eliminate the dependence on subsidies and create worldwide industry processing alternative and very available feedstocks once viewed as too wet to process such as forestry and farm residue, bamboo, waterborne biomass (e.g., algae, seaweed, kelp, etc.) and other high-moisture species.

The presently disclosed technology can also contribute to the value of conventional pelleting methods. Producing quality wood pellets with conventional means is a difficult challenge. With improved pellet durability as the goal, producers have searched extensively for an effective binder to improve pellet durability. When products of the present disclosure, such as dry pulp product, are mixed with conventionally-dried wood fiber, it can allow for greater densification of the pellet and better utilization of the lignin for binding.

The cellulosic component of lignocellulosic fiber has always been eyed as a potential base stock for cellulosic ethanol production. However, in order to be a viable feed stock, the lignin must be removed to some degree by the biorefineries to allow sufficient exposure of the cellulose to specific cellulases. The processes of the present disclosure can allow for the exposure and partial removal of lignin. Further processing can allow for the easy removal of the remaining lignin. Furthermore, the use of a low operating temperature can prevent the formation of inhibitors, which can have a negative impact on the production or effectiveness of various enzymes, such as, for example, cellulases, xylanases, amylases, lipases, maltases, phytases, sucrases, and combinations thereof. The processes offer greater exposure of the cellulose, increasing enzymatic effectiveness. Such products can also be applied to the production of biobutanol and other bioenergy products. The format of certain products rendered from the presently disclosed technology can also now be suitable to make cleaner biorefining approaches effective. These include, but are not limited to, the organosolv and Simultaneous Saccharification and Fermentation (SSF) processes.

In terms of drilling industries such as natural gas and petroleum, the present technology can be applied also. For example, lost circulation material is used extensively in the drilling industry. It helps to retard mud loss into fractures or highly permeable zones. The smaller particle sizes produced by the presently disclosed technology allows for a product with better flowability and permeability to seal cracks and crevices inherent in drilling for oil. In another example, tannates from products of the present technology have proven to be a very good, environmentally-safe drilling fluid.

The presently disclosed technology can also contribute directly to the food and beverage market. Products of the present technology can be used to better a number of the associated senses, including but not limited flavor enhancements, palate sensations, and smell augmentation. The products can also participate in nutrient upgrades and the production of sweetening aids and as supporting ingredients for foods containing flour.

Utilizing the tannins in products of the present disclosure and specifically the ellagitannins contained therein, wine producers can engineer the “dryness” of their product and emulate that effect conventionally produced in the oxidation process via time as made available by the oak barrels.

Similarly, some of the phenolic compounds found in products of the present disclosure can be supplemented into food products as a nutritional value; the anthocyanin in certain lignocellulosic species has been proven to improve cognitive functioning.

In another example, utilizing the SSF process subsequent to pulping, the acetoin produced can be used as a food flavoring in baked goods. The present technology can also participate very actively in the production of torula yeast, scientifically known as candida utilis. Products of the present disclosure can serve as a substrate for its growth. It is widely used as a flavoring in processed foods and pet foods. The form-factor of other products of the present disclosure can also accelerate the production of food-grade cellulose. This product is regularly found in as a thickener and bulker for tomato sauces, salad dressings, ice creams, energy bars, pasta, bread, and many other products.

The present technology can also contribute very effectively to the production of xylitol, a naturally occurring alcohol found in certain lignocellulosic feedstocks. It is widely used as a sugar substitute and in “sugar-free” chewing gums, mints, and other candies. The presently disclosed processes can condition the feedstock, such as birch, far more cost-effectively, lowering the overall cost. It also allows markets such as pulp-and-paper and biorefineries to establish co-product streams where conventionally that opportunity was lost.

Pulp is the fibrous material produced either chemically or mechanically (or by some combination of chemical and mechanical means) from wood or other cellulosic raw material. The wood cell has a nonliving cell wall, made of cellulose fibers, hemicellulose, and lignin which gives strength and support to the cell wall. Lignin holds the cellulose fibers together in the cell wall. Therefore, lignin must be removed to separate the individual cellulose fibers, which eventually become paper.

Conventional pulping processes inflict very difficult environmental issues. In fact, the industry is traditionally one of the largest contributors of industrial air, water, and land emissions in the world primarily due to the harsh chemicals used. Thousands of tons of pollutants are released each year. The industry is also one of the largest consumers of energy and water in the world, using more water to produce one ton of product than any other industry.

The industry is experiencing tremendous pressure from society to address these challenges. Research is being applied to the development of sustainable pulping mechanisms, including the use of environmentally-friendly chemicals and lower-energy approaches to mechanical conditioning of the feedstock.

Steam explosion is a process of great promise for the industry. However, in a conventional form, it has shown many economic problems which include the insufficient destruction of lignin-carbohydrate complex and, in the case of biorefinery and paper application, possible generation of fermentation inhibitors. Additionally, for the engineered lumber segment, the fiber also requires drying before it can be processed further.

The presently disclosed technology can offer substantial advantages to both the conventional process and the steam-explosion process. Relative to the conventional process, no harsh chemicals are used and little to no monosaccharide degradation occurs. The energy requirements are considerably less, and no environmental issues result. On the contrary, products disclosed herein, such as the liquid product, can capture the soil nutrients and tree biologics for application. The resulting fiber is also very susceptible to the action of cellulases.

In terms of bio-refineries and paper production, as a result of the effectiveness of processes of the present disclosure, cost-effective pulping processes such as organosolv pulping are now possible. This method uses organic solvents to break down the lignin and hemicellulose. This method is considered to be the cleanest of contemporary methods in use today.

In terms of products, the present technology can substantially reduce the cost necessary to produce cardboard, molded pulp, and fluff pulp as well. Most of the feedstock required to make these products today is obtained from the recycling industry. The feedstock requires much processing to render it clean and useful again, consequently creating additional environment issues.

Engineered lumber includes manufactured wood products which are produced by binding fiber together with adhesives, or other methods of fixation to form composite materials. The present technology can contribute directly to the production of densified wood, Medium Density Fiberboard (MDF), and particle board. The present technology can also contribute directly to the developing transparent wood markets as well.

All the aforementioned engineered lumber products are manufactured from wood chips, sawmill shavings, or even sawdust, and a synthetic resin or other suitable binder, which is pressed and extruded. Conventionally, the feedstock necessary for this production must be dried; the presently disclosed technology can inherently dry the feedstock and avoid this costly step in the process. Emissions are also consequently avoided, and the fractionated form-factor of the fiber produced from processes of the present disclosure can be conducive to creating a strong product. The products when produced conventionally also require binders, most of which are not sustainable and cause additional environment challenges, both in production and in disposal/recycling. The presently disclosed technology can require less binder. Additionally, the liquid extract produced by the presently disclosed technology can be developed into a sustainable binding product to serve other market interests as discussed previously.

Effective utilization of waste streams very regularly requires dewatering, drying, and conditioning the feedstock. This is conventionally accomplished with various belt presses, extruders and cyclone treatments. Thereafter, the waste is then reduced down in size with additional mechanical processing. The presently disclosed technology can consolidate all these processes into one and conditions the feedstock to an extent previously impossible.

For example, the presently disclosed technology can process spent coffee grains very efficiently and make them available for pellet production. The pellets can then be incinerated as solid fuel for heat or electricity production or utilized in the rapidly-increasing grilling industry as a flavored smoke product. In another example, the present technology can process poultry feather quills for the production of keratin that provides a never-available form-factor for thin film applications as well as many others. In another example, the present technology can process citrus peels into a very unique form that allows it to be more-efficiently used a number of industrial applications. The extracted liquid from processes of the present disclosure also has much potential, particularly in the pursuit of organic chemical synthesis.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

As used herein, the term “pulp” is understood to include lignocellulosic materials of varying moisture content, physical characteristics, bulk density, or species having been dewatered, dried, fractionated, and expanded.

As used herein, the term “exposed cellulose fiber” is understood to refer to cellulose fibers or fibrils that are not bound within a cellular wall. For example, cellulose fibers can be exposed via cell explosion processes of the present disclosure.

Disclosed herein are processes comprising: combining an additive with a feedstock to obtain a first mixture, the feedstock comprising a fibrous material and water, the fibrous material comprising lignin, cellulose, and hemicellulose; and condition the first mixture to obtain a liquid product and a dry pulp product.

Also disclosed herein are conditioning processes, machines, and methods for use in conjunction with the aforementioned processes.

Also disclosed herein are a liquid product made by the aforementioned processes, a dry pulp product and/or fibrous pulp material made by the aforementioned processes, and fibrous pellets made by the aforementioned processes.

Disclosed herein are processes, systems, and methods for processing and/or producing materials comprising a fibrous material. The fibrous material can comprise natural fibers, such as cellulosic fibers. For instance, the fibrous material can comprise wood fibers. The wood fibers can be provided in the form of a wood pulp or other lignocellulosic fibrous source. For instance, the wood fibers can be provided in the form of southern bleached softwood kraft pulp. Suitable examples of fibrous sources can include, but are not limited to, fluff pulp, dissolving pulp, mechanical pulp, chemical pulp, recovered paper pulp, semi-mechanical pulp, semi-chemical pulp, soft cook fully chemical pulp, consumer waste products such as clothes, viscose, rayon, lyocell, or any combination thereof. Additionally, the fibrous material can be any material that comprises lignin and hemicellulose.

The fibrous material can also be in the form of wood chips, wood fibers, or other wood sources. Other suitable examples of wood sources include hardwood, softwood, aspen, balsa, beech, birch, mahogany, hickory, maple, oak, teak Eucalyptus, pine, cedar, juniper, spruce, redwood, or any combination thereof. It is understood that any other known sources of wood fibers and lignocellulosic materials can be used. Alternatively, the fibrous material can be provided in the form of natural non-wood or alternative fibers. Suitable examples of natural non-wood alternative fibers that can make up the fibrous material can include, for example, barley, bagasse, bamboo, wheat and wheat straw, flax, hemp, kenaf, Arundo donax, corn stalk, jute, ramie, cotton, wool, rye, rice, Papyrus, esparto, sisal, grass, abaca, shrubs, Miscanthus, giant reed, alfalfa, woody vines, flowers, Wisteria, honeysuckle, Clematis, kudzu, coffee and other beans/legumes, Stevia and other functional plants, other lignocellulosic species, or any combination thereof. It is understood that the fibrous material can include any other natural fibers from any source or any combination of natural fibers. In some embodiments, the fibrous material can be provided from cellulosic fibers that can be prepared from the wood pulp or otherwise provided fiber source by means of a mechanical process such as hammer-milling or other comminution processes.

The fibrous material can comprise fibers having an average length from approximately 0.01 mm to 12 mm. For example, the fibrous material can comprise fibers having an average length of 0.01 mm or greater (e.g., 0.05 mm or greater, 0.10 mm or greater, 0.15 mm or greater, 0.20 mm or greater, 0.25 mm or greater, 0.30 mm or greater, 0.35 mm or greater, 0.40 mm or greater, 0.45 mm or greater, 0.50 mm or greater, 0.55 mm or greater, 0.60 mm or greater, 0.65 mm or greater, 0.70 mm or greater, 0.75 mm or greater, 0.80 mm or greater, 0.85 mm or greater, 0.90 mm or greater, 0.95 mm or greater, 1.0 mm or greater, 1.1 mm or greater, 1.2 mm or greater, 1.3 mm or greater, 1.4 mm or greater, 1.5 mm or greater, 1.6 mm or greater, 1.7 mm or greater, 1.8 mm or greater, 1.9 mm or greater, 2.0 mm or greater, 2.1 mm or greater, 2.2 mm or greater, 2.3 mm or greater, 2.4 mm or greater, 2.5 mm or greater, 2.6 mm or greater, 2.7 mm or greater, 2.8 mm or greater, 2.9 mm or greater, 3.0 mm or greater, 3.5 mm or greater, 4.0 mm or greater, 4.5 mm or greater, 5.0 mm or greater, 5.5 mm or greater, 6.0 mm or greater, 6.5 mm or greater, 7.0 mm or greater, 7.5 mm or greater, 8.0 mm or greater, 8.5 mm or greater, 9.0 mm or greater, 9.5 mm or greater, 10 mm or greater, 10.5 mm or greater, 11 mm or greater, or 11.5 mm or greater or any value between, e.g., 0.07 mm or 10.26 mm).

In some embodiments, the fibrous material can comprise fibers having an average length of 12 mm or less (e.g., 11.5 mm or less, 11 mm or less, 10.5 mm or less, 10 mm or less, 9.5 mm or less, 9.0 mm or less, 8.5 mm or less, 8.0 mm or less, 7.5 mm or less, 7.0 mm or less, 6.5 mm or less, 6.0 mm or less, 5.5 mm or less, 5.0 mm or less, 4.5 mm or less, 4.0 mm or less, 3.5 mm or less, 3.0 mm or less, 2.9 mm or less, 2.8 mm or less, 2.7 mm or less, 2.6 mm or less, 2.5 mm or less, 2.4 mm or less, 2.3 mm or less, 2.2 mm or less, 2.1 mm or less, 2.0 mm or less, 1.9 mm or less, 1.8 mm or less, 1.7 mm or less, 1.6 mm or less, 1.5 mm or less 1.4 mm or less, 1.3 mm or less, 1.2 mm or less, 1.1 mm or less, 1.0 mm or less, 0.95 mm or less, 0.90 mm or less, 0.85 mm or less, 0.80 mm or less, 0.75 mm or less, 0.70 mm or less, 0.65 mm or less, 0.60 mm or less, 0.55 mm or less, 0.50 mm or less, 0.45 mm or less, 0.40 mm or less, 0.35 mm or less, 0.30 mm or less, 0.25 mm or less, 0.20 mm or less, 0.15 mm or less, 0.10 mm or less, 0.05 mm or less, or any value between, e.g., 0.07 mm or 10.26 mm).

In some embodiments, the fibrous material has a length of 0.01 mm to 12 mm (e.g., 0.3 mm to 7 mm, 0.5 mm to 5 mm, 0.7 mm to 2.8 mm, 2.9 mm to 8 mm, 8 mm to 12 mm, 0.01 mm to 1 mm). In some embodiments, the fibrous material comprises a blend of one or more fibers that are of different average fiber lengths. In other words, in some embodiments, the fibrous material has bimodal (or trimodal, etc.) average fiber length. The fibrous material can, in some examples, have an average length of fibers from about 1 angstrom to about 5000 microns.

The fibrous material can comprise fibers having various cross-sectional shapes (e.g., round, scalloped oval, cruciform, haxachannel, etc.). In some embodiments, the average maximum cross-sectional size of the fibers in the fibrous material (i.e., the average diameter for a round fiber) is from 100 nanometers to 1000 microns. In some embodiments, the fibrous material can have an average maximum cross-sectional size of 100 nanometers or greater (e.g., 150 nanometers or greater, 250 nanometers or greater, 350 nanometers or greater, 450 nanometers or greater, 550 nanometers or greater, 650 nanometers or greater, 750 nanometers or greater, 850 nanometers or greater, 950 nanometers or greater, 1 micron or greater, 5 microns or greater, 10 microns or greater, 15 microns or greater, 20 microns or greater, 25 microns or greater, 30 microns or greater, 35 microns or greater, 40 microns or greater, 45 microns or greater, 50 microns or greater, 55 microns or greater, 60 microns or greater, 65 microns or greater, 70 microns or greater, 75 microns or greater, 80 microns or greater, 85 microns or greater, 90 microns or greater, 95 microns or greater, 100 microns or greater, 200 microns or greater, 300 microns or greater, 400 microns or greater, 500 microns or greater, 600 microns or greater, 700 microns or greater, 800 microns or greater, or 900 microns or greater, or any value between, e.g., 700 nanometers or 524 microns).

In some embodiments, the fibrous material can have an average maximum cross-sectional size of 1000 microns or less (e.g., 900 microns or less, 800 microns or less, 700 microns or less, 600 microns or less, 500 microns or less, 400 microns or less, 300 microns or less, 200 microns or less, 100 microns or less, 95 microns or less, 90 microns or less, 85 microns or less, 80 microns or less, 75 microns or less, 70 microns or less, 65 microns or less, 60 microns or less, 55 microns or less, 50 microns or less, 45 microns or less, 40 microns or less, 35 microns or less, 30 microns or less, 25 microns or less, 20 microns or less, 15 microns or less, 10 microns or less, 5 microns or less, 1 micron or less, 900 nanometers or less, 800 nanometers or less, 700 nanometers or less, 600 nanometers or less, 500 nanometers or less, 400 nanometers or less, 300 nanometers or less, 200 nanometers or less, or any value between, e.g., 750 nanometers or 52 microns).

In some embodiments, the fibrous material can have an average maximum cross-sectional size of about 100 nanometers to about 1000 microns (e.g., 100 nanometers to 1 micron, 1 micron to 10 microns, 10 microns to 25 microns, 25 microns to 50 microns, 50 microns to 75 microns, 75 microns to 100 microns, 25 microns to 75 microns, 25 microns to 100 microns, 100 nanometers to 10 microns, 100 nanometers to 25 microns, 1 micron to 25 microns, 10 microns to 75 microns, from 1 micron to 1000 microns, from 1 micron to 900 microns, from 1 micron to 800 microns, from 1 micron to 700 microns, from 1 micron to 600 microns, from 1 micron to 500 microns, from 100 microns to 1000 microns, from 100 microns to 900 microns, from 100 microns to 800 microns, from 100 microns to 700 microns, from 100 microns to 600 microns, or from 100 microns to 500 microns, or any value between, e.g., 720 nanometers or 235 microns). In some embodiments, the fibrous material comprises a blend of one or more fibers that are of different average maximum cross-sectional size. In other words, in some embodiments, the fibrous material has bimodal (or trimodal, etc.) average maximum cross-sectional size.

Also disclosed herein is an additive material. The additive material can comprise, for example, a small molecule material, a fatty acid, a phospholipid, a surfactant, or a polymer. Without wishing to be bound by any particular scientific theory, the additive material can interact with lignin in the fibrous material to weaken the cellular structure of the fibrous material. The additive material can also act in a catalytic manner and/or as a drag-reducing agent during processing.

The additive can be a water-soluble material capable of interacting with lignin. The additive can be a surfactant, for example. A variety of surfactants can be included in the present disclosure to interact with the fibrous material (e.g., weakening the lignin), act in a catalytic manner, and act as a drag-reducing or dewatering agent during processing. The surfactants used in the present invention can contain a lipophilic nonpolar hydrocarbon group and a polar or ionic (e.g., cationic, anionic, zwitterionic, etc.) functional hydrophilic group. The anionic or polar functional group can be a carboxylate, ester, amine, amide, imide, hydroxyl, ether, nitrile, phosphate, sulfate, or sulfonate. The cationic functional group may be a primary amine, secondary amine, tertiary amine or quandary amine. The surfactants that are useful in the present invention may be used alone or in combination. Accordingly, any combination of surfactants may include anionic, cationic, nonionic, zwitterionic, amphoteric and ampholytic surfactants.

Accordingly, the surfactants for use in the present invention may be anionic, including, but not limited to, sulfonates such as alkyl sulfonates, alkylbenzene sulfonates, alpha olefin sulfonates, paraffin sulfonates, and alkyl ester sulfonates; sulfates such as alkyl sulfates, alkyl alkoxy sulfates, and alkyl alkoxylated sulfates; phosphates such as monoalkyl phosphates and dialkyl phosphates; phosphonates; carboxylates such as fatty acids, alkyl alkoxy carboxylates, sarcosinates, isethionates, and taurates. Specific examples of carboxylates are sodium cocoyl isethionate, sodium methyl oleoyl taurate, sodium stearate, sodium laureth carboxylate, sodium polyacrylate, sodium trideceth carboxylate, sodium lauryl sarcosinate, sodium carboxymethyl cellulose, lauroyl sarcosine, and cocoyl sarcosinate. Specific examples of sulfates include sodium dodecyl sulfate (SDS), sodium lauryl sulfate, sodium lauryl ether sulfate, cationsodium laureth sulfate, sodium trideceth sulfate, sodium tridecyl sulfate, sodium cocyl sulfate, and lauric monoglyceride sodium sulfate.

Suitable sulfonate surfactants include, but are not limited to, alkyl sulfonates, aryl sulfonates, lignosulfonate, linear alkylbenzene sulfonates, monoalkyl and dialkyl sulfosuccinates, and monoalkyl and dialkyl sulfosuccinamates. Each alkyl group independently contains about two to twenty carbons and can also be ethoxylated with up to about 8 units, preferably up to about 6 units, on average, e.g., 2, 3, or 4 units, of ethylene oxide, per each alkyl group. Illustrative examples of alky and aryl sulfonates are sodium tridecyl benzene sulfonate (STBS) and sodium dodecylbenzene sulfonate (SDBS).

Illustrative examples of sulfosuccinates include, but are not limited to, dimethicone copolyol sulfosuccinate, diamyl sulfosuccinate, dicapryl sulfosuccinate, dicyclohexyl sulfosuccinate, diheptyl sulfosuccinate, dihexyl sulfosuccinate, diisobutyl sulfosuccinate, dioctyl sulfosuccinate, dioctyl sodium sulfosuccinate (DOSS), C12-15 pareth sulfosuccinate, cetearyl sulfosuccinate, cocopolyglucose sulfosuccinate, cocoyl butyl gluceth-10 sulfosuccinate, deceth-5 sulfosuccinate, deceth-6 sulfosuccinate, dihydroxyethyl sulfosuccinylundecylenate, hydrogenated cottonseed glyceride sulfosuccinate, isodecyl sulfosuccinate, isostearyl sulfosuccinate, laneth-5 sulfosuccinate, laureth sulfosuccinate, laureth-12 sulfosuccinate, laureth-6 sulfosuccinate, laureth-9 sulfosuccinate, lauryl sulfosuccinate, nonoxynol-10 sulfosuccinate, oleth-3 sulfosuccinate, oleyl sulfosuccinate, PEG-10 laurylcitrate sulfosuccinate, sitosereth-14 sulfosuccinate, stearyl sulfosuccinate, tallow, tridecyl sulfosuccinate, ditridecyl sulfosuccinate, bisglycol ricinosulfosuccinate, di(1,3-di-methylbutyl) sulfosuccinate, and silicone copolyol sulfosuccinates.

Illustrative examples of sulfosuccinamates include, but are not limited to, lauramido-MEA sulfosuccinate, oleamido PEG-2 sulfosuccinate, cocamido MIPA-sulfosuccinate, cocamido PEG-3 sulfosuccinate, isostearamido MEA-sulfosuccinate, isostearamido MIPA-sulfosuccinate, lauramido MEA-sulfosuccinate, lauramido PEG-2 sulfosuccinate, lauramido PEG-5 sulfosuccinate, myristamido MEA-sulfosuccinate, oleamido MEA-sulfosuccinate, oleamido PIPA-sulfosuccinate, oleamido PEG-2 sulfosuccinate, palmitamido PEG-2 sulfosuccinate, palmitoleamido PEG-2 sulfosuccinate, PEG-4 cocamido MIPA-sulfosuccinate, ricinoleamido MEA-sulfosuccinate, stearamido MEA-sulfosuccinate, stearyl sulfosuccinamate, tallamido MEA-sulfosuccinate, tallow sulfosuccinamate, tallowamido MEA-sulfosuccinate, undecylenamido MEA-sulfosuccinate, undecylenamido PEG-2 sulfosuccinate, wheat germamido MEA-sulfosuccinate, and wheat germamido PEG-2 sulfosuccinate.

For an anionic surfactant, the counter ion is typically sodium but may alternatively be potassium, lithium, calcium, magnesium, ammonium, amines (primary, secondary, tertiary or quandary) or other organic bases. Exemplary amines include isopropyl amine, ethanolamine, diethanolamine, and triethanolamine. Mixtures of the above cations may also be used.

In some embodiments, the surfactants for use in the present invention may also be cationic, so long as at least one surfactant bearing a net positive charge is also included. Such cationic surfactants include, but are not limited to, primarily organic amines, primary, secondary, tertiary or quaternary. For a cationic surfactant, the counter ion can be chloride, bromide, methosulfate, ethosulfate, lactate, saccharinate, phosphate, acetate, and other organic acid anions. Examples of cationic amines include polyethoxylated oleyl/stearyl amine, ethoxylated tallow amine, cocoalkylamine, oleylamine, and tallow alkyl amine.

Examples of quaternary amines with a single long alkyl group are cetyl trimethyl ammonium bromide (CETAB), cetyl trimethyl ammonium chloride (CETAC), dodecyltrimethylammonium bromide, myristyl trimethyl ammonium bromide, stearyl dimethyl benzyl ammonium chloride, oleyl dimethyl benzyl ammonium chloride, lauryl trimethyl ammonium methosulfate (also known as cocotrimonium methosulfate), cetyl-dimethyl hydroxyethyl ammonium dihydrogen phosphate, bassuamidopropylkonium chloride, cocotrimonium chloride, distearyldimonium chloride, wheat germ-amidopropalkonium chloride, benzalkonium chloride, stearyl octyidimonium methosulfate, isostearaminopropal-konium chloride, dihydroxypropyl PEG-5 linoleammonium chloride, PEG-2 stearmonium chloride, behentrimonium chloride, dicetyl dimonium chloride, tallow trimonium chloride and behenamidopropyl ethyl dimonium ethosulfate.

Examples of quaternary amines with two long alkyl groups are distearyldimonium chloride, dicetyl dimonium chloride, benzethonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, and hydroxypropyl bisstearyldimonium chloride.

Quaternary ammonium compounds of imidazoline derivatives include, for example, isostearyl benzylimidonium chloride, cocoyl benzyl hydroxyethyl imidazolinium chloride, cocoyl hydroxyethylimidazolinium PG-chloride phosphate, and stearyl hydroxyethylimidonium chloride. Other heterocyclic quaternary ammonium compounds, such as dodecylpyridinium chloride and cetylpyridinium chloride, can also be used.

The surfactants for use in the present invention may be nonionic, including, but not limited to, polyalkylene oxide carboxylic acid esters, fatty acid esters, fatty alcohols, ethoxylated fatty alcohols, poloxamers, polyalkylene oxidesm alkanolamides, polyacrylamides, alkoxylated alkanolamides, polyethylene glycol monoalkyl ether, and alkyl polysaccharides. Polyalkylene oxide carboxylic acid esters have one or two carboxylic ester moieties each with about 8 to 20 carbons and a polyalkylene oxide moiety containing about 5 to 200 alkylene oxide units. An ethoxylated fatty alcohol contains an ethylene oxide moiety containing about 5 to 150 ethylene oxide units and a fatty alcohol moiety with about 6 to about 30 carbons. The fatty alcohol moiety can be cyclic, straight, or branched, and saturated or unsaturated. Some examples of ethoxylated fatty alcohols include ethylene glycol ethers of oleth alcohol, steareth alcohol, lauryl alcohol and isocetyl alcohol. Poloxamers are ethylene oxide and propylene oxide block copolymers, having from about 15 to about 100 moles of ethylene oxide. Alkyl polysaccharide (“APS”) surfactants (e.g. alkyl polyglycosides) contain a hydrophobic group with about 6 to about 30 carbons and a polysaccharide (e.g., polyglycoside) as the hydrophilic group.

Specific examples of suitable nonionic surfactants include alkanolamides such as cocamide diethanolamide (“DEA”), cocamide monoethanolamide (“MEA”), cocamide monoisopropanolamide (“MIPA”), PEG-5 cocamide MEA, lauramide DEA, and lauramide MEA; alkyl amine oxides such as lauramine oxide, poly-N-vinyl formamide, cocamine oxide, cocamidopropylamine oxide, and lauramidopropylamine oxide; polyalkylene oxides such as polyethylene oxide (PEO), polypropylene oxide, and polybutylene oxide; polyethylene glycol (PEG) and polypropylene glycol and block copolymers thereof; polysorbates or Tweens such as polysorbate 20, polysorbate 40, polysorbate 60, and polysorbate 80; polyacrylamide-co-sodium acrylate (PAAM-co-NaA); polyacrylamide-co-(sodium2-(acrylamido)-2methylpropanesulfonate) (PAAM-co-NaAMPS); polyacrylamide-co-(sodium3-(acrylamido)-3methylbutanoate) (PAAM-co-NaAMB); and polyacrylamide-co-diacetone acrylamide (PAAM-coDAAM); polyampholytes (containing both negative and positive charges in the same polymeric chain) based on acrylamide (AM), sodium 2-acrylamido-2-methylpropanesulfonate (NaAMPS), (2-acrylamido2-methylpropyl)trimethylammonium chloride (AMPTAC), sodium 3-acrylamido-3-methylbutanoate (NaAMB), and 3-((2-acrylamido-2-methylpropyl)dimethylammonio)-1-propanesulfonate (AMPDAPS); gums such as Guar gum, Xanthan gum, Lucas Bean gum, Gellan gum, and gum Arabic; sorbitan laurate, sorbitan distearate, fatty acids or fatty acid esters such as lauric acid, isostearic acid, and PEG-150 distearate; fatty alcohols or ethoxylated fatty alcohols such as lauryl alcohol, alkylpolyglucosides such as decyl glucoside, lauryl glucoside, and coco glucoside.

The surfactants for use in the present invention may be zwitterionic, meaning the same molecule has both a formal positive and negative charge. The positive charge group can be quaternary ammonium, phosphonium, or sulfonium, whereas the negative charge group can be carboxylate, sulfonate, sulfate, phosphate or phosphonate. Similar to other classes of surfactants, the hydrophobic moiety may contain one or more long, straight, cyclic, or branched, aliphatic chains of about 8 to 18 carbon atoms. Specific examples of zwitterionic surfactants include alkyl betaines such as cocodimethyl carboxymethyl betaine, coco betaine, lauryl dimethyl carboxymethyl betaine, lauryl dimethyl alpha-carboxyethyl betaine, cetyl dimethyl carboxymethyl betaine, lauryl bis-(2-hydroxyethyl) carboxy methyl betaine, stearyl bis-(2-hydroxypropyl) carboxymethyl betaine, oleyl dimethyl gamma-carboxypropyl betaine, and lauryl bis-(2-hydroxypropyl) alphacarboxy-ethyl betaine, amidopropyl betaines; lechetins (phosphatidylcholine); and alkyl sultaines such as cocodimethyl sulfopropyl betaine, stearyidimethyl sulfopropyl betaine, lauryl dimethyl sulfoethyl betaine, lauryl bis-(2-hydroxyethyl) sulfopropyl betaine, and alkylamidopropylhydroxy sultaines.

The surfactants for use in the present invention may be amphoteric. Examples of suitable amphoteric surfactants include ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates. Specific examples are cocoamphoacetate, cocoamphopropionate, cocoamphodiacetate, lauroamphoacetate, lauroamphodiacetate, lauroamphodipropionate, lauroamphodiacetate, cocoamphopropyl sulfonate, caproamphodiacetate, caproamphoacetate, caproamphodipropionate, and stearoamphoacetate.

The surfactants for use in the present invention may also be a polymer such as N-substituted polyisobutenyl succinimides and succinates, alkyl methacrylate vinyl pyrrolidinone copolymers, polyvinylpyrrolidones, alkyl methacrylate-dialkylaminoethyl methacrylate copolymers, alkylmethacrylate polyethylene glycol methacrylate copolymers, and polystearamides.

Alternatively, the surfactant may be an oil-based dispersant, which includes alkylsuccinimide, succinate esters, high molecular weight amines, and Mannich base and phosphoric acid derivatives. Some specific examples are polyisobutenyl succinimide-polyethylenepolyamine, polyisobutenyl succinic ester, polyisobutenyl hydroxybenzyl-polyethylenepolyamine, and bis-hydroxypropyl phosphorate.

The surfactant used in the present invention may also be a combination of two or more selected from the group consisting of anionic, cationic, nonionic, zwitterionic, amphoteric, and ampholytic surfactants. Suitable examples of a combination of two or more surfactants of the same type include, but are not limited to, a mixture of two anionic surfactants, a mixture of three anionic surfactants, a mixture of four anionic surfactants, a mixture of two cationic surfactants, a mixture of three cationic surfactants, a mixture of four cationic surfactants, a mixture of two nonionic surfactants, a mixture of three nonionic surfactants, a mixture of four nonionic surfactants, a mixture of two zwitterionic surfactants, a mixture of three zwitterionic surfactants, a mixture of four zwitterionic surfactants, a mixture of two amphoteric surfactants, a mixture of three amphoteric surfactants, a mixture of four amphoteric surfactants, a mixture of two ampholytic surfactants, a mixture of three ampholytic surfactants, and a mixture of four ampholytic surfactants.

Suitable examples of a combination of two surfactants of different types include, but are not limited to, a mixture of one anionic and one cationic surfactant, a mixture of one anionic and one nonionic surfactant, a mixture of one anionic and one zwitterionic surfactant, a mixture of one anionic and one amphoteric surfactant, a mixture of one anionic and one ampholytic surfactant, a mixture of one cationic and one nonionic surfactant, a mixture of one cationic and one zwitterionic surfactant, a mixture of one cationic and one amphoteric surfactant, a mixture of one cationic and one ampholytic surfactant, a mixture of one nonionic and one zwitterionic surfactant, a mixture of one nonionic and one amphoteric surfactant, a mixture of one nonionic and one ampholytic surfactant, a mixture of one zwitterionic and one amphoteric surfactant, a mixture of one zwitterionic and one ampholytic surfactant, and a mixture of one amphoteric and one ampholytic surfactant. A combination of two or more surfactants of the same type, e.g., a mixture of two anionic surfactants, is also included in the present invention.

The additive can have a molecular weight from about 500 g/mol to about 10,000,000 g/mol. The additive can have a molecular weight from about 1,000 g/mol to about 10,000,000 g/mol. The additive can have a molecular weight from about 1,000 g/mol to about 8,000,000 g/mol. The additive can alternatively have a molecular weight from about 5,000 g/mol to about 10,000,000 g/mol, from about 100,000 g/mol to about 10,000,000 g/mol, from about 500 g/mol to about 1,000,000 g/mol, from about 1,000 g/mol to about 1,000,000 g/mol, from about 1,000 g/mol to about 2,000,000 g/mol, from about 1,000 g/mol to about 3,000,000 g/mol, or from about 500 g/mol to about 8,000,000 g/mol.

Embodiments of the present disclosure can provide a dry pulp product. The dry pulp product can be made from fibrous material using processes of the present disclosure and can have an exploded cellular structure. The dry pulp product can be further processed into pellets, briquettes, or other value-added products. The dry pulp product can have a particle size (e.g., average particle diameter) from about 1 mm to about 10 mm (e.g., from 1.5 mm to 9.5 mm, from 2 mm to 9 mm, from 2.5 mm to 8.5 mm, from 3 mm to 8 mm, from 3.5 mm to 7.5 mm, from 4 mm to 7 mm, from 4.5 mm to 6.5 mm, or from 5 mm to 6 mm, or any value between, e.g., 1.7 mm to 3.6 mm).

Embodiments of the present disclosure can provide a fibrous pellet, comprising a fibrous material comprising lignin and water. The fibrous pellets of the present disclosure can be substantially dewatered. In other words, the fibrous pellet can comprise water in an amount of about 20% or less (e.g., 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4.5% or less, 4% or less, 3.5% or less, 3% or less, 2.5% or less, 2% or less, 1.5% or less, 1% or less, or 0.5% or less) by weight, based on the total weight of the fibrous pellet.

In some embodiments, the fibrous pellet can comprise water in an amount of about 0.1% or greater (e.g., 19% or greater, 18% or greater, 17% or greater, 16% or greater, 15% or greater, 14% or greater, 13% or greater, 12% or greater, 11% or greater, 10% or greater, 9% or greater, 8% or greater, 7% or greater, 6% or greater, 5% or greater, 4.5% or greater, 4% or greater, 3.5% or greater, 3% or greater, 2.5% or greater, 2% or greater, 1.5% or greater, 1% or greater, or 0.5% or greater) by weight, based on the total weight of the fibrous pellet.

In some embodiments, the fibrous pellet can comprise water in an amount from about 0.1% to about 20% (e.g., from 0.1% to 19%, from 0.5% to 18%, from 1% to 17%, from 1% to 20%, from 1% to 19%, from 1% to 18%, from 1% to 16%, from 2% to 18%, from 3% to 17%, from 4% to 16%, from 5% to 15%, from 6% to 14%, from 7% to 13%, from 8% to 12%, from 9% to 11%, from 0.5% to 4.5%, from 1% to 5%, from 1% to 4.5%, from 1% to 4%, from 1.5% to 3.5%, or from 2% to 3%) by weight, based on the total weight of the fibrous pellet.

The fibrous pellets of the present disclosure can present substantially improved mechanical properties as well. For example, the fibrous pellet can have a pellet durability index (PDI) of 90 or greater (e.g., 91 or greater, 92 or greater, 93 or greater, 94 or greater, 95 or greater, 96 or greater, 97 or greater, 98 or greater, 99 or greater, or 100). The PDI of the fibrous pellets can be measured using, for example, ASAE Standard S269.5 R2016. Additionally, the fibrous pellets of the present disclosure can have improved structural integrity. For example, the fibrous pellets can undergo substantially minimal degradation when submerged in water from about 1 minute to about 1 year. As used herein, “substantially minimal degradation” is defined by a bulk density of the fibrous pellets changing by an amount of 10% or less. In other words, the fibrous pellets undergo minimal swelling and/or water adsorption when submerged.

The fibrous pellet can also have a bulk density of about 15 kg/m³ or greater (e.g., 20 kg/m³ or greater, 25 kg/m³ or greater, 30 kg/m³ or greater, 35 kg/m³ or greater, 40 kg/m³ or greater, 45 kg/m³ or greater, 50 kg/m³ or greater, 60 kg/m³ or greater, 70 kg/m³ or greater, 80 kg/m³ or greater, 90 kg/m³ or greater, 100 kg/m³ or greater, 150 kg/m³ or greater, 200 kg/m³ or greater, 250 kg/m³ or greater, 300 kg/m³ or greater, 350 kg/m³ or greater, 400 kg/m³ or greater, 450 kg/m³ or greater, 500 kg/m³ or greater, 550 kg/m³ or greater, 600 kg/m³ or greater, 650 kg/m³ or greater, 700 kg/m³ or greater, or 750 kg/m³ or greater, or any value between, e.g., 274 kg/m³ or 593 kg/m³).

The fibrous pellet can have a bulk density of about 800 kg/m³ or less (e.g., 20 kg/m³ or less, 25 kg/m³ or less, 30 kg/m³ or less, 35 kg/m³ or less, 40 kg/m³ or less, 45 kg/m³ or less, 50 kg/m³ or less, 60 kg/m³ or less, 70 kg/m³ or less, 80 kg/m³ or less, 90 kg/m³ or less, 100 kg/m³ or less, 150 kg/m³ or less, 200 kg/m³ or less, 250 kg/m³ or less, 300 kg/m³ or less, 350 kg/m³ or less, 400 kg/m³ or less, 450 kg/m³ or less, 500 kg/m³ or less, 550 kg/m³ or less, 600 kg/m³ or less, 650 kg/m³ or less, 700 kg/m³ or less, or 750 kg/m³ or less, or any value between, e.g., 274 kg/m³ or 593 kg/m³).

The fibrous pellet can have a bulk density from about 15 kg/m³ to about 800 kg/m³ (e.g., from 20 kg/m³ to 800 kg/m³, from 25 kg/m³ to 800 kg/m³, from 30 kg/m³ to 800 kg/m³, from 35 kg/m³ to 800 kg/m³, from 40 kg/m³ to 800 kg/m³, from 45 kg/m³ to 800 kg/m³, from 50 kg/m³ to 800 kg/m³, from 60 kg/m³ to 800 kg/m³, from 70 kg/m³ to 800 kg/m³, from 80 kg/m³ to 800 kg/m³, from 90 kg/m³ to 800 kg/m³, from 100 kg/m³ to 800 kg/m³, from 150 kg/m³ to 800 kg/m³, from 200 kg/m³ to 800 kg/m³, from 250 kg/m³ to 800 kg/m³, from 300 kg/m³ to 800 kg/m³, from 350 kg/m³ to 800 kg/m³, from 400 kg/m³ to 800 kg/m³, from 450 kg/m³ to 800 kg/m³, from 500 kg/m³ to 800 kg/m³, from 550 kg/m³ to 800 kg/m³, from 600 kg/m³ to 800 kg/m³, from 650 kg/m³ to 800 kg/m³, from 700 kg/m³ to 800 kg/m³, from 750 kg/m³ to 800 kg/m³, from 100 kg/m³ to 750 kg/m³, from 100 kg/m³ to 700 kg/m³, from 150 kg/m³ to 650 kg/m³, from 250 kg/m³ to 750 kg/m³, from 300 kg/m³ to 700 kg/m³, from 350 kg/m³ to 650 kg/m³, from 400 kg/m³ to 600 kg/m³, or from 450 kg/m³ to 550 kg/m³, or any value between, e.g., 74 kg/m³ to 693 kg/m³).

Embodiments of the present disclosure can also provide a liquid product derived from the fibrous material, the liquid product comprising solid or liquid particulates, bio-stimulant compounds, minerals, amino acids, organic acids, proteins, water, cellulose, and lignin. The bio-stimulant compounds can include compounds such as humic acid, fulvic acid, or other organic acids. The liquid product can also comprise other bio-stimulant compounds including, but not limited to, humic acid derivates, humates, other organic acids, humic substances, humin, lignosulfonates, lactic acids, acetic acids, formic acids, citric acids, oxalic acids, uric acids, malic acids, other derivatives of soil organic matter, humic matter, other bioactive compounds and the like, or any combination thereof. The minerals can include potassium, phosphorus, nitrogen, barium, calcium, magnesium, sulfur, sodium, iron, manganese, zinc, copper, molybdenum, cobalt, nickel, chromium, aluminum, titanium other natural minerals and the like, or any combination thereof. The liquid product can further comprise amino acids, such as glutamic acid or tryptophan. The liquid product can further comprise other volatile and non-volatile organic compounds.

The liquid product can include two major fractions-water and dry matter. Nutrient reports on a dry basis refer to the weight of nutrient per unit weight of dry matter in the sample. The nutrients (energy, protein, minerals, and vitamins) are found in the dry matter fraction, so the percentage of each respective nutrient in the liquid product can be calculated based on the total weight of the dry matter. The dry matter basis assumes no water is present; 100% dry matter. This expression of nutrient composition is commonly used to compare forages and other biomass materials that may differ in dry matter content.

Certain nutrients, such as nitrogen, phosphorus or potassium can be analyzed by manure analysis. Nutrient reports on a wet or “as-is” basis refer to the weight of nutrient per unit weight of wet or “as-is” manure or liquid sample (e.g., pounds of nitrogen per ton of manure for broiler litter).

The bio-stimulant and/or bio-nutrient compounds can be present in the liquid product in an amount of about 0.001% or greater (e.g., 0.005% or greater, 0.01% or greater, 0.05% or greater, 0.1% or greater, 0.2% or greater, 0.3% or greater, 0.4% or greater, 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater, 2% or greater, 2.5% or greater, 3% or greater, 3.5% or greater, 4% or greater, 4.5% or greater, 5% or greater, 5.5% or greater, 6% or greater, 6.5% or greater, 7% or greater, 7.5% or greater, 8% or greater, 8.5% or greater, 9% or greater, or 9.5% or greater, or any value between, e.g., 4.2% or 7.7%) by weight, based on the total weight of dry matter (DM) of the liquid product.

In some embodiments, the bio-stimulant and/or bio-nutrient compounds can be present in the liquid product in an amount of about 10% or less (e.g., 0.005% or less, 0.01% or less, 0.05% or less, 0.1% or less, 0.2% or less, 0.3% or less, 0.4% or less, 0.5% or less, 0.6% or less, 0.7% or less, 0.8% or less, 0.9% or less, 1% or less, 1.1% or less, 1.2% or less, 1.3% or less, 1.4% or less, 1.5% or less, 2% or less, 2.5% or less, 3% or less, 3.5% or less, 4% or less, 4.5% or less, 5% or less, 5.5% or less, 6% or less, 6.5% or less, 7% or less, 7.5% or less, 8% or less, 8.5% or less, 9% or less, or 9.5% or less, or any value between, e.g., 4.2% or 7.7%) by weight, based on the total weight of dry matter (DM) of the liquid product.

In some embodiments, the bio-stimulant and/or bio-nutrient compounds can be present in the liquid product in an amount from about 0.001% to about 10% (e.g., from 0.005% to 10%, from 0.01% to 10%, from 0.05% to 10%, from 0.1% to 10%, from 0.2% to 10%, from 0.3% to 10%, from 0.4% to 10%, from 0.5% to 10%, from 0.6% to 10%, from 0.7% to 10%, from 0.8% to 10%, from 0.9% to 10% from 1% to 10%, from 1% to 9.5%, from 1% to 9%, from 1.5% to 8.5%, from 2% to 8%, from 2.5% to 7.5%, from 3% to 7%, from 3% to 6.5%, from 3% to 6%, from 3% to 5.5%, from 3% to 5%, from 2.5% to 5%, from 2% to 5%, from 1.5% to 5%, from 1.4% to 5%, from 1.3% to 5%, from 1.2% to 5%, from 1.1% to 5%, from 1% to 5%, from 0.9% to 5%, from 0.8% to 5%, from 0.7% to 5%, from 0.6% to 5%, from 0.5% to 5%, from 0.4% to 5%, from 0.3% to 5%, from 0.2% to 5%, or from 0.1% to 5%, or any value between, e.g., from 0.042% to 7.7%) by weight, based on the total weight of dry matter (DM) of the liquid product.

The primary and/or secondary metabolites can be present in the liquid product in an amount of about 0.001% or greater (e.g., 0.005% or greater, 0.01% or greater, 0.05% or greater, 0.1% or greater, 0.2% or greater, 0.3% or greater, 0.4% or greater, 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater, 2% or greater, 2.5% or greater, 3% or greater, 3.5% or greater, 4% or greater, 4.5% or greater, 5% or greater, 5.5% or greater, 6% or greater, 6.5% or greater, 7% or greater, 7.5% or greater, 8% or greater, 8.5% or greater, 9% or greater, or 9.5% or greater, or any value between, e.g., 4.2% or 7.7% or greater) by weight, based on the total weight of dry matter (DM) of the liquid product.

In some examples, the liquid product can have tannins, terpenes, and/or polyphenols in an amount of about 0.001% or greater (e.g., 0.005% or greater, 0.01% or greater, 0.05% or greater, 0.1% or greater, 0.2% or greater, 0.3% or greater, 0.4% or greater, 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater, 2% or greater, 2.5% or greater, 3% or greater, 3.5% or greater, 4% or greater, 4.5% or greater, 5% or greater, 5.5% or greater, 6% or greater, 6.5% or greater, 7% or greater, 7.5% or greater, 8% or greater, 8.5% or greater, 9% or greater, or 9.5% or greater, or any value between, e.g., 4.2% or 7.7%) by weight, based on the total weight of dry matter (DM) of the liquid product.

The liquid product can comprise water in an amount of about 25% or greater (e.g., 30% or greater, 35% or greater, 40% or greater, 45% or greater, 50% or greater, 55% or greater, 60% or greater, 65% or greater, 70% or greater, 75% or greater, 80% or greater, or 85% or greater) by weight, based on the total weight of the liquid product. In some embodiments, the liquid product can comprise water in an amount of about 99% or less (e.g., 55% or less, 60% or less, 65% or less, 70% or less, 75% or less, 80% or less, or 85% or less) by weight, based on the total weight of the liquid product. In some embodiments, the liquid product can comprise water in an amount from about 10% to about 99% (e.g., from 15% to 98%, from 20% to 97%, or from 25% to 96%, from 30% to 95%, from 40% to 90%, or from 50% to 80%, or any value between, e.g., 22% or 77%) by weight, based on the total weight of the liquid product, or a total weight of dry matter (DM) of the liquid product.

The liquid product can also comprise lignin in an amount of about 0.01% or greater (e.g., 0.05% or greater, 0.1% or greater, 0.5% or greater, 1% or greater, 2% or greater, 3% or greater, 4% or greater, 5% or greater, 6% or greater, 7% or greater, 8% or greater, 9% or greater, 10% or greater, 15% or greater, 20% or greater, 25% or greater, 30% or greater, 35% or greater, 40% or greater, 45% or greater, 50% or greater, 55% or greater, 60% or greater, 65% or greater, or 70% or greater, or any value between, e.g., 4.2% or 67% or greater) by weight, based on the total weight of dry matter (DM) of the liquid product.

In some embodiments, the liquid product can comprise lignin in an amount of about 75% or less (e.g., 0.05% or less, 0.1% or less, 0.5% or less, 1% or less, 2% or less, 3% or less, 4% or less, 5% or less, 6% or less, 7% or less, 8% or less, 9% or less, 10% or less, 15% or less, 20% or less, 25% or less, 30% or less, 35% or less, 40% or less, 45% or less, 50% or less, 55% or less, 60% or less, 65% or less, or 70% or less, or any value between, e.g., 4.2% or 57% or less) by weight, based on the total weight of dry matter (DM) of the liquid product.

In some embodiments, the liquid product can comprise lignin in an amount from about 0.01% to about 75% (e.g., from 0.05% to 75%, from 0.1% to 75%, from 0.5% to 75%, from 1% to 75%, from 2% to 75%, from 2% to 75%, from 3% to 75%, from 4% to 75%, from 5% to 75%, from 6% to 75%, from 7% to 75%, from 8% to 75%, from 9% to 75%, from 10% to 75%, from 15% to 75%, from 20% to 75%, from 25% to 75%, from 30% to 70%, from 35% to 65%, from 40% to 60%, or from 45% to 55%, or any value between, e.g., 12% to 57.2%) by weight, based on the total weight of dry matter (DM) of the liquid product.

In some embodiments, the liquid product can comprise cellulose and/or nanocellulose in an amount of 0.01 or greater (e.g., 0.05% or greater, 0.1% or greater, 0.5% or greater, 1% or greater, 2% or greater, 3% or greater, 4% or greater, 5% or greater, 6% or greater, 7% or greater, 8% or greater, 9% or greater, 10% or greater, 15% or greater, 20% or greater, 25% or greater, 30% or greater, 35% or greater, 40% or greater, 45% or greater, 50% or greater, 55% or greater, 60% or greater, 65% or greater, or 70% or greater, or any value between, e.g., 42.4% or 67% or greater) by weight, based on the total weight of the liquid product, or a total weight of dry matter (DM) of the liquid product. As would be appreciated by one of skill in the relevant art, the composition and the content of the lignin, hemicellulose, and cellulose components in feedstock will vary due to the differences in species, types, and sources of feedstock.

The liquid product can also comprise various dry matter. In other words, the liquid product can have a solids content of about 0.0001% or greater (e.g., 0.0005% or greater, 0.001% or greater, 0.005% or greater, 0.01% or greater, 0.05% or greater, 0.1% or greater, 0.5% or greater, 1% or greater, 1.5% or greater, 2% or greater, 2.5% or greater, 3% or greater, 3.5% or greater, 4% or greater, 4.5% or greater, 5% or greater, 6% or greater, 7% or greater, 8% or greater, 9% or greater, 10% or greater, 11% or greater, 12% or greater, 13% or greater, 14% or greater, 15% or greater, 16% or greater, 17% or greater, 18% or greater, or 19% or greater, or any value between, e.g., 0.02% or 12.7% or greater) by weight, based on the total weight of the liquid product or a total weight of dry matter (DM) of the liquid product.

In some embodiments, the liquid product can have a solids content of about 20% or less (e.g., 0.0005% or less, 0.001% or less, 0.005% or less, 0.01% or less, 0.05% or less, 0.1% or less, 0.5% or less, 1% or less, 1.5% or less, 2% or less, 2.5% or less, 3% or less, 3.5% or less, 4% or less, 4.5% or less, 5% or less, 6% or less, 7% or less, 8% or less, 9% or less, 10% or less, 11% or less, 12% or less, 13% or less, 14% or less, 15% or less, 16% or less, 17% or less, 18% or less, or 19% or less, or any value between, e.g., 4.2% or 7.7% or less) by weight, based on the total weight of dry matter (DM) of the liquid product.

In some embodiments, the liquid product can have a solids content from about 0.0001% to about 20% (e.g., from 0.0005% to 20%, from 0.001% to 20%, from 0.005% to 20%, from 0.01% to 20%, from 0.05% to 20%, from 0.1% to 20%, from 0.5% to 20%, from 1% to 20%, from 0.0005% to 19%, from 0.001% to 18%, from 0.005% to 17%, from 0.01% to 16%, from 0.05% to 15%, from 0.1% to 14%, from 0.5% to 13%, from 1% to 12%, from 1.5% to 11%, from 2% to 10%, from 2% to 9%, from 2% to 8%, from 2% to 7%, from 2% to 6%, from 2% to 5%, from 2.5% to 4.5%, or from 3% to 4%, or any value between, e.g., 0.026% to 17.7%) by weight, based on the total weight of dry matter (DM) of the liquid product.

As would be appreciated by one of skill in the relevant art, the composition and the content of the components in the liquid product will vary due to the differences in species, types, and sources of feedstock the liquid product is extracted from. It is understood that the liquid product can include any combination of ingredients discussed herein, including without limitation, any percentage of each respective combination to create the whole liquid product. For instance, a liquid product may include approximately 80% of water and 5% VOCs, with the remaining 15% of the liquid product comprising dry matter including, for example, approximately 15% DM fiber (e.g., lignin), approximately 15% DM minerals (e.g., potassium, phosphorus, nitrogen, calcium, magnesium, sulfur, sodium, iron, manganese, zinc, copper), approximately 20% DM protein (e.g., crude protein, soluble protein), approximately 25% DM carbohydrates (e.g., starch, crude fat), approximately 15% DM bio-stimulant compounds (e.g., pipenes, camphenes, kaolins, polyacrylamides, humic acids, fulvic acids), approximately 10% DM amino acids (e.g., alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine), such that approximately 100% of the dry matter is made up of any combination components.

The liquid product can also be acidic. For instance, the liquid product can have a pH of about 7 or less (e.g., 6.5 or less, 6 or less, 5.5 or less, 5 or less, 4.5 or less, 4 or less, 3.5 or less, 3 or less, 2.5 or less, 2 or less, 1.5 or less, 1 or less or 0.5 or less). In some embodiments, the liquid product can have a pH of about 0 or greater (e.g., 6.5 or greater, 6 or greater, 5.5 or greater, 5 or greater, 4.5 or greater, 4 or greater, 3.5 or greater, 3 or greater, 2.5 or greater, 2 or greater, 1.5 or greater, 1 or greater, or 0.5 or greater, or any value between, e.g., 2.3 or 6.7 or greater). In some embodiments, the liquid product can have a pH from about 0 to about 7 (e.g., from 0.5 to 6.5, from 1 to 6, from 1.5 to 5.5, from 2 to 5, from 2.5 to 4.5, from 3 to 4, from 0 to 6.5, from 0 to 6, from 0 to 5.5, from 0 to 5, from 0 to 4.5, or from 0 to 4, or any value between, e.g., 0.7 to 5.7).

Additionally, the liquid product can entrain substantially all VOCs present in the feedstock in a liquid form. In other words, the process of making the liquid product can emit substantially undetectable amounts of VOCs because the VOCs are substantially contained in the liquid product. As used herein, the term “substantially undetectable amounts of VOCs” refers to emitting VOCs in an amount of about 1 ppm or less. As used herein, “substantially all,” with respect to the VOC concentration in the liquid product, shall mean that the liquid product comprises at least 85%, at least 90%, or at least 95% of the VOCs present in the biomass material at the time the biomass material enters the cellular explosion process.

Also disclosed herein is a method of promoting growth in a plant using the liquid products described above. The method can comprise administering a liquid product to said plant. A variety of liquid products can be formulated as described above and are contemplated and understood to be within the scope of this disclosure.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

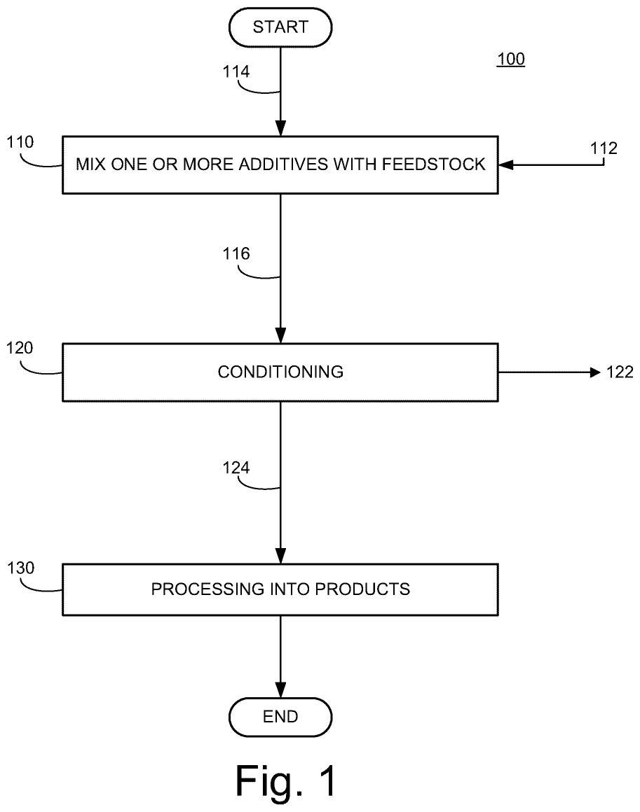

FIG. 1 illustrates a flowchart of an exemplary process 100 of the present disclosure. As shown in block 110, additive 112 can be combined with feedstock 114 to obtain first mixture 116. Feedstock 114 can comprise a fibrous material and water, and the fibrous material can comprise lignin and be selected from the fibrous materials of the present disclosure. Examples of additive 112 are described above, but it is to be understood that other elements can be present in additive 112, such as inhibitors, defoamers, indicators, dyes, and the like. Process 100 can then proceed to block 120 or to other steps of process 100 not shown.

Referring to feedstock 114, feedstock 114 can comprise water in an amount of about 10% or greater (e.g., 15% or greater, 20% or greater, 25% or greater, 30% or greater, 35% or greater, 40% or greater, 45% or greater, 50% or greater, 55% or greater, 60% or greater, 65% or greater, 70% or greater, 75% or greater, 80% or greater, 85% or greater, or 90% or greater) by weight, based on the total weight of feedstock 114. Feedstock 114 can also comprise water in an amount of about 95% or less (e.g., 15% or less, 20% or less, 25% or less, 30% or less, 35% or less, 40% or less, 45% or less, 50% or less, 55% or less, 60% or less, 65% or less, 70% or less, 75% or less, 80% or less, 85% or less, or 90% or less) by weight, based on the total weight of feedstock 114. Alternatively, feedstock 114 can comprise water in an amount from about 10% to about 95% (e.g., from 10% to 90%, from 15% to 85%, from 20% to 80%, from 25% to 75%, from 30% to 70%, from 35% to 65%, from 40% to 60%, or from 45% to 55%) by weight, based on the total weight of feedstock 114.

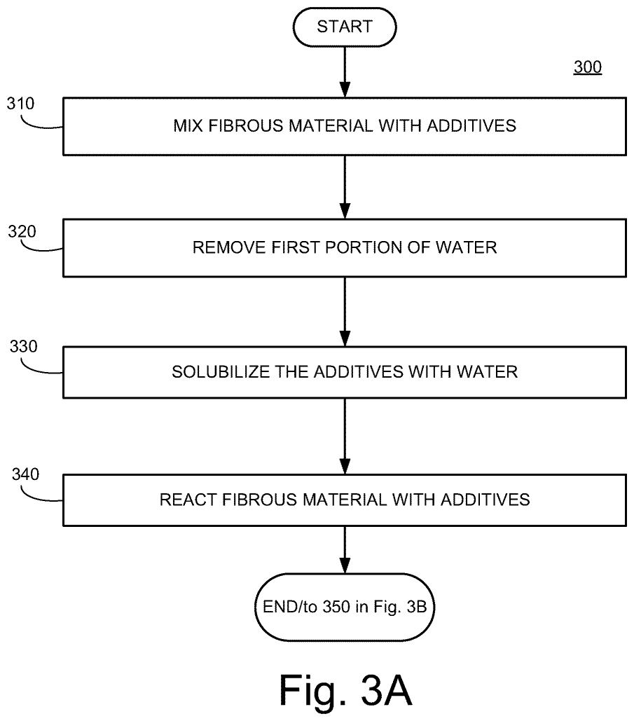

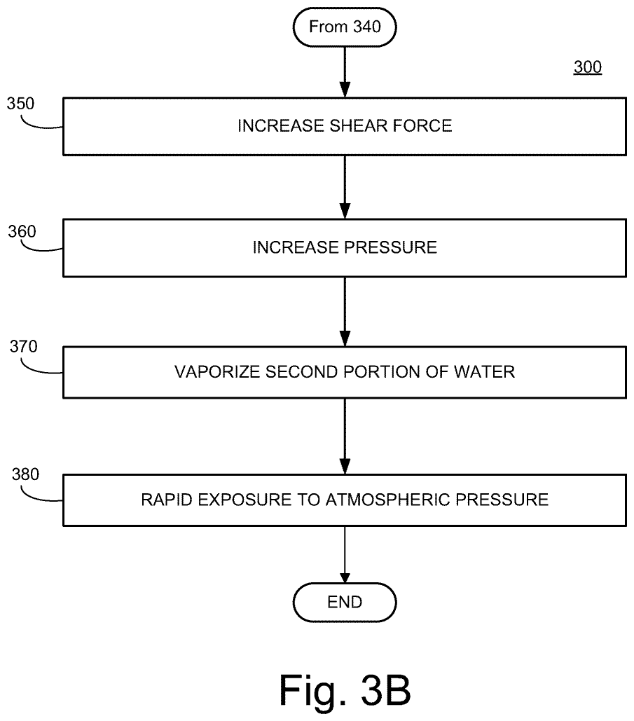

Referring now to block 120, in block 120, first mixture 116 can be conditioned to obtain liquid product 122 and dry pulp product 124. Further steps of the conditioning of block 120 are outlined in greater detail by FIG. 3. Liquid product 122 can entrain substantially all VOCs present in feedstock 114 in a liquid form. In other words, the conditioning step of block 120 can emit a substantially undetectable amount of VOCs because the VOCs are substantially contained in liquid product 122. Examples of liquid product 122 are described above, but it is to be understood that liquid product 122 can have a composition according to any embodiments of the present disclosure.

The conditioning step of block 120 can occur at a temperature requiring little to no added heat. In other words, the conditioning can substantially self-generate heat without a need for an external heat source. For example, the conditioning step of block 120 can occur at a temperature of about 550° F. or less (e.g., 540° F. or less, 530° F. or less, 520° F. or less, 310° F. or less, 500° F. or less, 490° F. or less, 480° F. or less, 470° F. or less, 460° F. or less, 450° F. or less, 440° F. or less, 430° F. or less, 420° F. or less, or 410° F. or less). In addition, the conditioning step of block 120 can also occur at a temperature of about 350° F. or less (e.g., 340° F. or less, 330° F. or less, 320° F. or less, 310° F. or less, 300° F. or less, 290° F. or less, 280° F. or less, 270° F. or less, 260° F. or less, 250° F. or less, 240° F. or less, 230° F. or less, 220° F. or less, or 210° F. or less). The conditioning step of block 120 can additionally occur at a temperature from about 180° F. to about 350° F. (e.g., from 185° F. to 345° F., from 190° F. to 340° F., from 200° F. to 330° F., from 210° F. to 320° F., from 220° F. to 310° F., from 230° F. to 300° F., from 240° F. to 290° F., from 250° F. to 300° F., from 200° F. to 310° F., from 210° F. to 320° F., from 220° F. to 330° F., from 230° F. to 340° F., or from 240° F. to 350° F.).

Dry pulp product 124 can comprise a fibrous material and water, and the fibrous material can be substantially similar to the fibrous material of feedstock 114. Dry pulp product 124 can also be substantially dewatered. For example, dry pulp product 124 can comprise water in an amount of about 30% or less (e.g., 25% or less, 20% or less, 15% or less, 10% or less, 5% or less, 4% or less, 3% or less, 2% or less, or 1% or less) by weight, based on the total weight of dry pulp product 124. Dry pulp product 124 can also comprise water in an amount of about 0.5% or greater (e.g., 25% or greater, 20% or greater, 15% or greater, 10% or greater, 5% or greater, 4% or greater, 3% or greater, 2% or greater, or 1% or greater) by weight, based on the total weight of dry pulp product 124. Dry pulp product 124 can alternatively comprise water in an amount from about 0.5% to about 30% (from 1% to 25%, from 2% to 20%, from 3% to 15%, from 4% to 10%, from 5% to 10%, from 5% to 15%, from 5% to 20%, from 5% to 25%, from 5% to 30%, from 10% to 30%, from 15% to 30%, or from 20% to 30%) by weight, based on the total weight of dry pulp product 124. Process 100 can terminate after block 120, or process 100 can then proceed to block 130. Process 100 can additionally proceed to other steps of process 100 not shown.

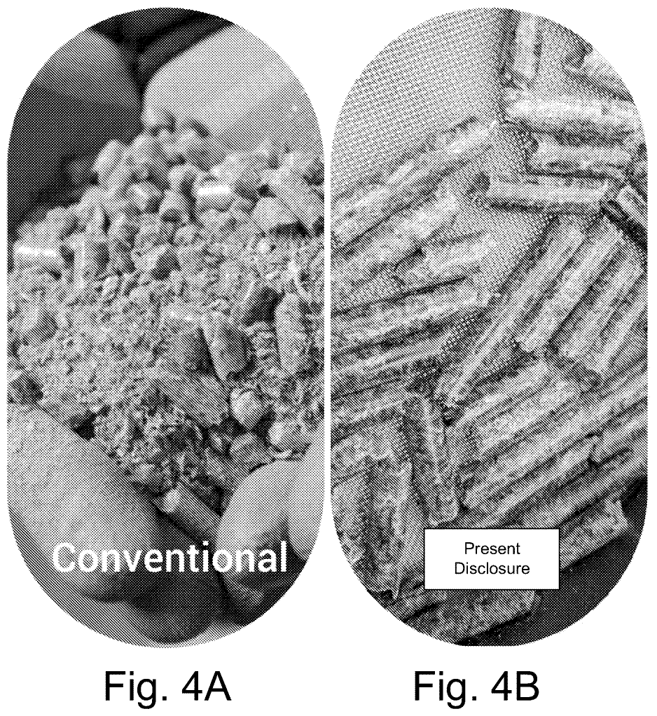

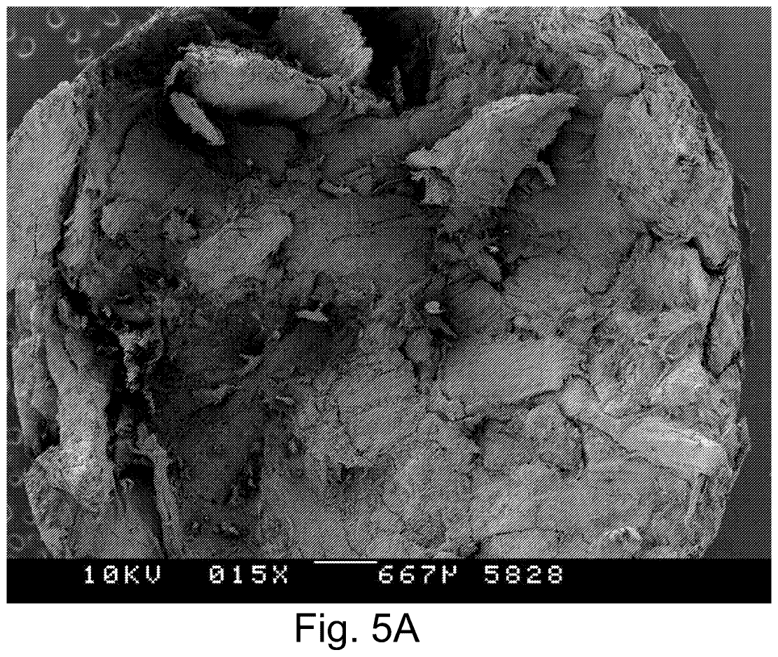

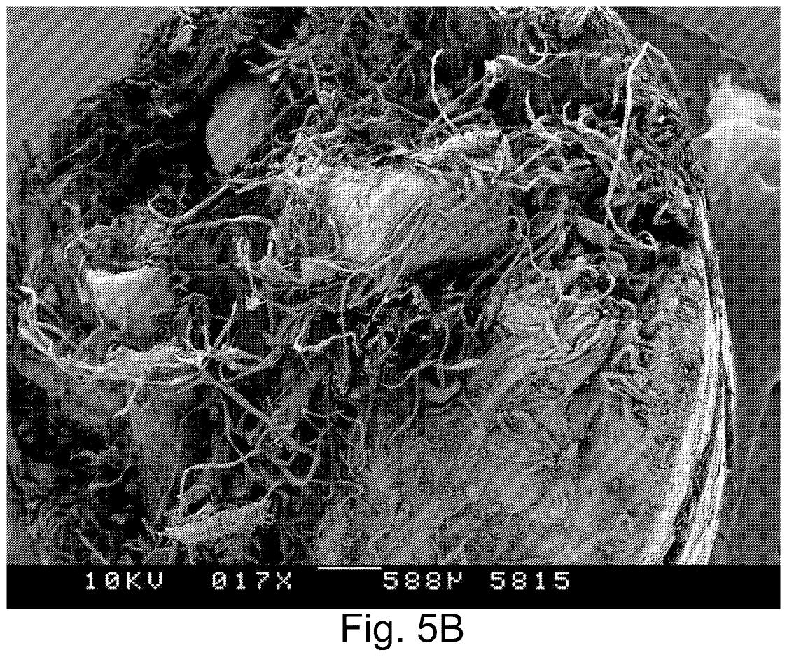

In block 130, dry pulp product 124 can be further processed into useful products. For example, dry pulp product 124 can be pelletized to form a fibrous pellet. Examples of a fibrous pellet are described above, but it is to be understood that the fibrous pellet can have a composition according to any embodiments of the present disclosure. A fibrous pellet manufactured from the presently disclosed technology is shown in FIG. 4B, compared with a fibrous pellet produced from a conventional process, shown in FIG. 4A. Additionally, a scanning electron microscope (SEM) image of a fibrous pellet produced by a conventional process is shown in FIG. 5A compared to a SEM image of a fibrous pellet produced by processes of the present disclosure shown in FIG. 5B. Alternatively, dry pulp product 124 can be ground into fine particulates. The fine particulates can be used in packaging material, fiber boards, paper boards, and the like. Dry pulp product 124 can also be used for paper making or to produce other lignocellulosic-based products. Dry pulp product 124 can also be used as a binder fiber to improve the mechanical properties of other fibrous materials. Process 100 can terminate and complete after block 130. However, in other embodiments, process 100 can continue on to other process steps not shown.

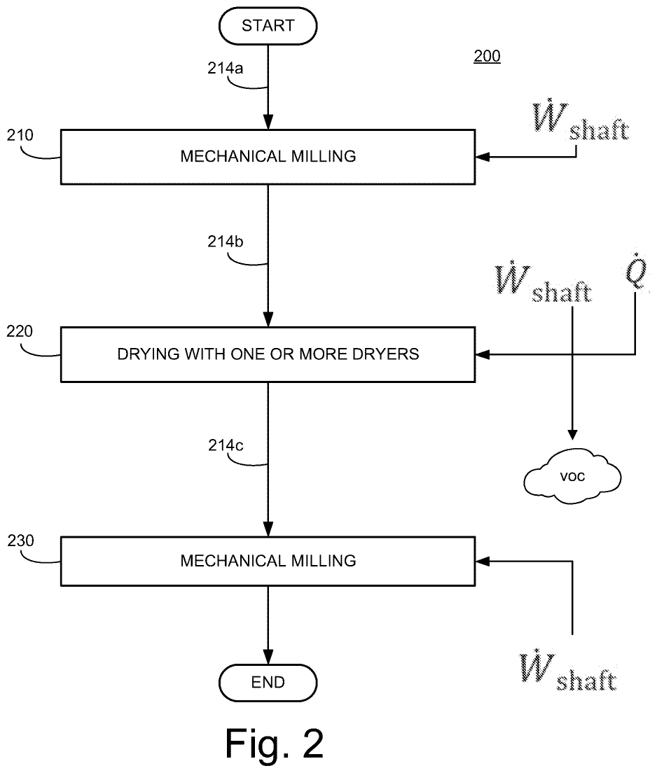

FIG. 2 illustrates a flowchart of a traditional process 200. As shown in block 210, feedstock 214a can undergo a mechanical milling process. The mechanical milling process also requires a first amount of shaft work to complete. The work required for block 210 traditionally is time consuming and expensive, resulting in an inefficient process. The equipment needed for the mechanical milling process is expensive as well and is complicated and difficult to keep maintained. Therefore, block 210 of traditional process 200 is undesirable. Traditional process 200 can then proceed to block 220.

In block 220, the milled feedstock 214b can be dried by one or more dryers to obtain dry feedstock 214c. The one or more dryers require additional shaft work to move milled feedstock 214b through the dryers, and the one or more dryers also require added heat to raise the temperature of milled feedstock 214b. The energy required to heat the one or more dryers, typically to evaporate water, is extremely high and prohibitively cost-intensive. Additionally, the high temperatures used to dry milled feedstock 214b result in the release of several VOCs. The VOCs must then either be further treated, requiring additional expensive equipment and energy requirements; or the VOCs are simply released to the atmosphere, causing harmful environmental effects. Therefore, block 220 of traditional process 200 is undesirable. Traditional process 200 can then proceed to block 230.

In block 230, dry feedstock 214c can undergo a mechanical milling process to obtain a dry pulp product 234. This mechanical milling process also requires a second amount of shaft work to complete, as in block 210. The work required for block 230 traditionally is time consuming and expensive, resulting in an inefficient process. The equipment needed for the mechanical milling process is expensive as well and is complicated and difficult to keep maintained. Furthermore, the mechanical milling process cannot fully pulp, or comminute, dry feedstock 214c. The fibers must be ground up, reducing the overall strength; or left in-tact, increasing clumping and decreasing uniformity. Therefore, block 230 of traditional process 200 is undesirable. Traditional process 200 can terminate and complete after block 230. However, in other embodiments, traditional process 200 can continue on to other process steps not shown.

In contrast to traditional process 200, the processes of the present disclosure, such as process 100 in FIG. 1, need very little additional shaft work and little to no added heat. The processes of the present disclosure can additionally substantially entrain all VOCs in the liquid form of the liquid product, as described above, reducing the overall environmental impact. Additionally, due to having little added heat, the fibers in the fibrous material can undergo less hornification during processes of the present disclosure. This results in mechanically superior fibers that are far more compressible than fibers produced from traditional processes. Therefore, processes of the present disclosure are more cost-effective, energy-efficient, and environmentally friendly than traditional processes used to accomplish the same goals.

FIG. 3a illustrates a flowchart of an exemplary conditioning process 300 of the present disclosure. As would be appreciated, conditioning process 300 can occur substantially during block 120 of FIG. 1. As shown, in block 310, the fibrous material (i.e., in first mixture 116) can substantially interact with the additive. This interaction can form a substantially enhanced material between the additive and the fibrous material. Without wishing to be bound by any scientific theory, the additive can interact with the lignin in the fibrous material to decrease the rigidity of the lignocellulosic cells and increase the plasticity of the lignin. Conditioning process 300 can then proceed to block 320 or to other steps of conditioning process 300 not shown.

In block 320, a first portion of water in the fibrous material (i.e., the enhanced material from block 310) can be liberated. Without wishing to be bound by any scientific theory, the additive can have a dewatering or drag reducing effect on the fibrous material to liberate a first amount of free water from the fibrous material. This effect increases the amount of water removed by conditioning process 300 can reduces the need for additional drying steps. Conditioning process 300 can then proceed to block 330 or to other steps of conditioning process 300 not shown.

In block 330, the fibrous material (i.e., in the enhanced material) can be infused with the additive. Without wishing to be bound by any scientific theory, the liberated first portion of water can solubilize the additive, allowing the additive to infuse into the fibrous material. Conditioning process 300 can then proceed to block 340 or to other steps of conditioning process 300 not shown.

In block 340, the fibrous material can interact with the infused additive to weaken the lignin in the fibrous material. As described above in block 310, without wishing to be bound by any scientific theory, the additive can interact with the lignin in the fibrous material to decrease the rigidity of the lignocellulosic cells and increase the plasticity of the lignin. The infusing of block 330 can further increase the interaction and can homogenize the enhanced material further in block 340. Conditioning process 300 can then proceed to block 350 as shown in FIG. 3b, proceed to other steps of conditioning process 300 not shown, or terminate after block 340.

FIG. 3b illustrates a flowchart of an exemplary conditioning process 300 of the present disclosure. Systems and machines for implementing the same can be found described in greater detail in FIG. 4. As shown, in block 350, a pressure gradient can be applied to the fibrous material. This pressure increase can cause a temperature of the material to increase. Without wishing to be bound by any scientific theory, the drag-reducing properties of the additive can increase the frictional forces on the fibrous material. Because the lignin in the fibrous material has decreased rigidity and increased plasticity due to the additive, the lignin (and therefore the fibrous material) can remain intact without breaking as the temperature increases. Conditioning process 300 can then proceed to block 360 or to other steps of conditioning process 300 not shown.

In block 360, a shear force can be applied to the fibrous material. The applied shear force can increase the frictional forces acting on the fibrous material, further increasing the internal temperature of the fibrous material. Because the lignin in the fibrous material has decreased rigidity and increased plasticity due to the additive, the lignin (and therefore the fibrous material) can remain intact without breaking as the temperature increases. Conditioning process 300 can then proceed to block 370 or to other steps of conditioning process 300 not shown.

In block 370, a second portion of water in the fibrous material (i.e., the enhanced material) can be vaporized by fractionating the fibrous material. As would be appreciated, the shear and frictional forces can fractionate the fibrous material, releasing additional free water. The temperature increase due to the shear force and pressure gradient can also vaporize the free water as it is released. Without wishing to be bound by any scientific theory, the lignin in the cell walls of the fibrous material, having been plasticized by the additive, can now “balloon” under pressure. In other words, as water contained inside of the individual cells of the fibrous material begins to vaporize due to the temperature increases of the pressure gradient and shear/frictional forces, the plasticized lignin in the cell walls can expand without rupturing, as in a balloon being filled with hot air. As volumes of cells increase under frictional and shear forces, and increased temperatures and pressures, the cells can remain intact while the fibrous material can further fractionate. Conditioning process 300 can then proceed to block 380 or to other steps of conditioning process 300 not shown.

In block 380, the fibrous material (i.e., in the enhanced material) can be exposed to atmospheric pressure rapidly. Without wishing to be bound by any scientific theory, this rapid depressurization of the fibrous material can cause the chemo-mechanical cellular explosion of the fibrous material. In other words, the “ballooned” cells in the fibrous material can now fully rupture, releasing intracellular water and further fractionating the fibrous material. As would be appreciated, the fibrous material can undergo immense stress during conditioning due to the increased pressure gradient, shear force, frictional force, and temperature to result in expanded cells containing vaporized water. The cells can expand due to the interaction of the lignin with the additive, without wishing to be bound by any scientific theory. The rapid return to atmospheric conditions of the fibrous material can induce the chemo-mechanical cellular explosion process to release a final portion of water and obtain dry pulp product 124. It will also be appreciated that the liberated portions of water during conditioning process 300 can contain other components and can be recovered as liquid product 122. Conditioning process 300 can then terminate after block 380 or can proceed to other steps of conditioning process 300 not shown.

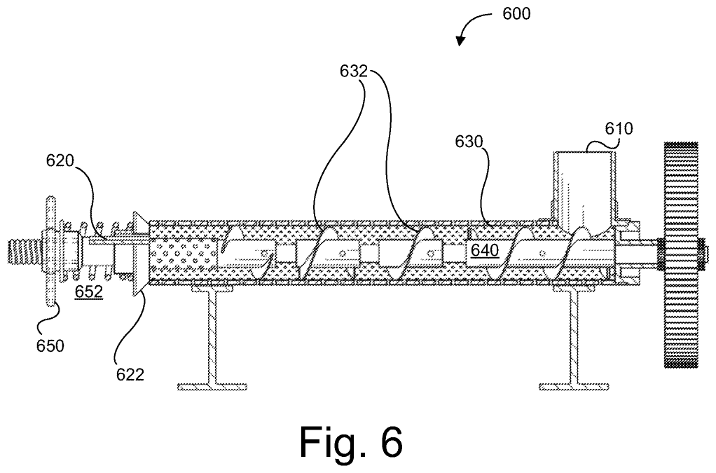

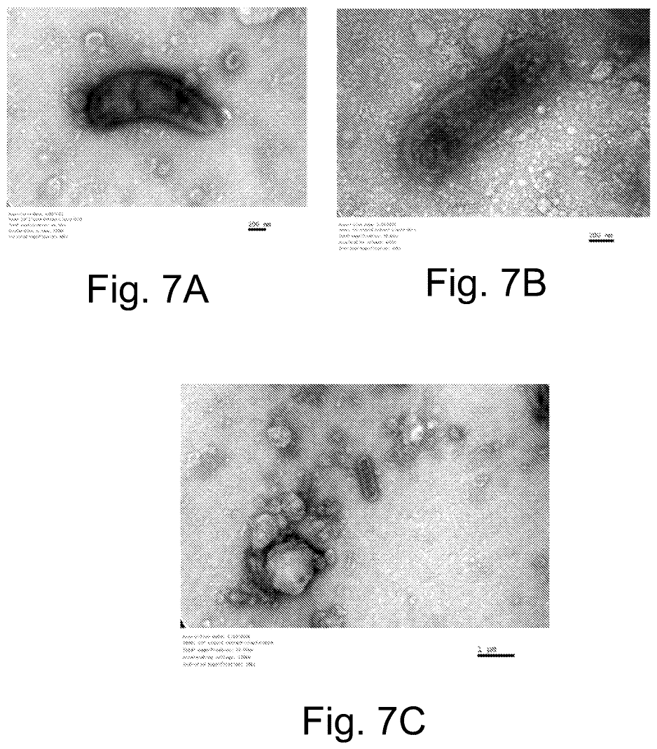

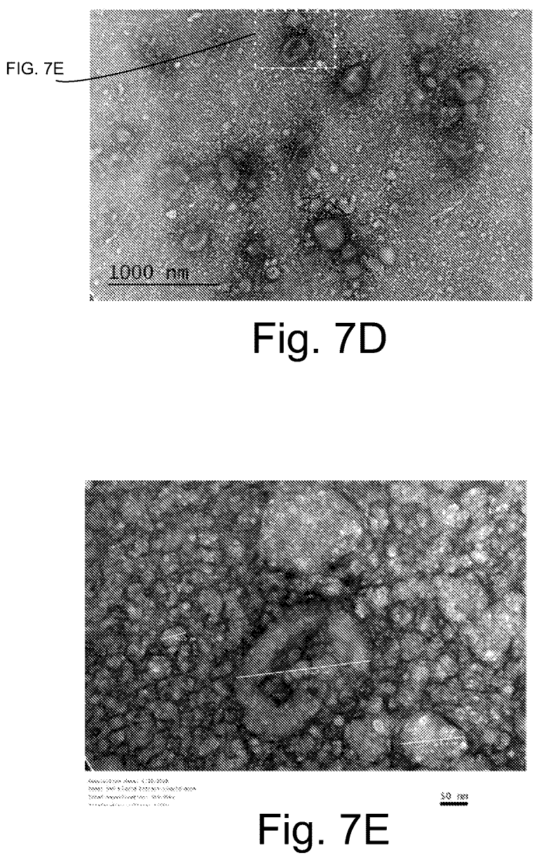

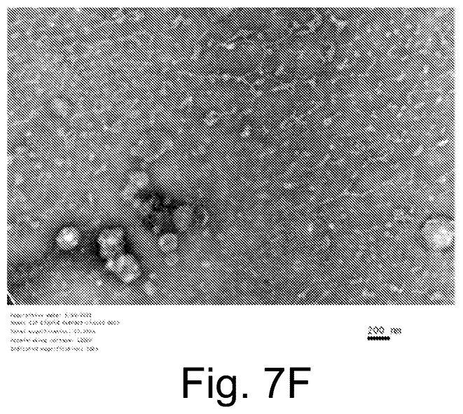

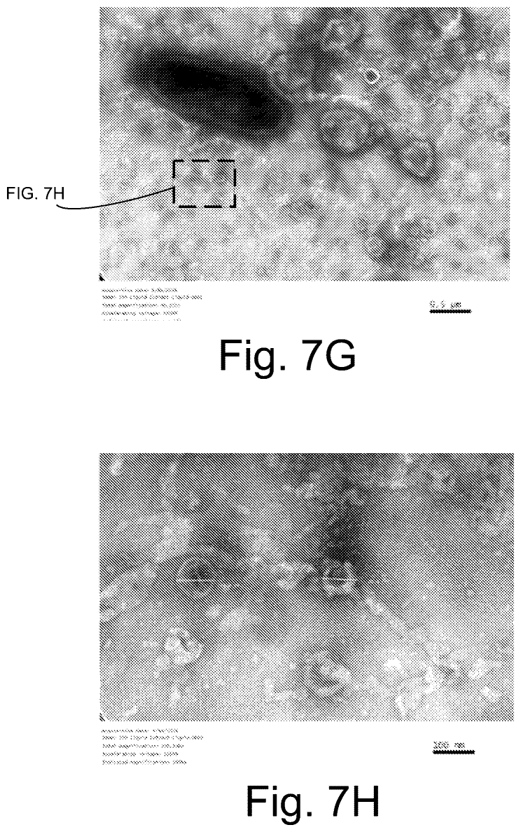

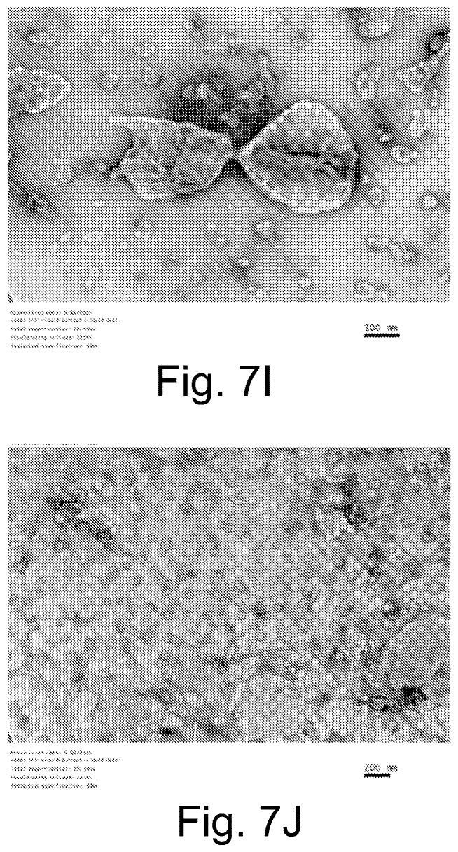

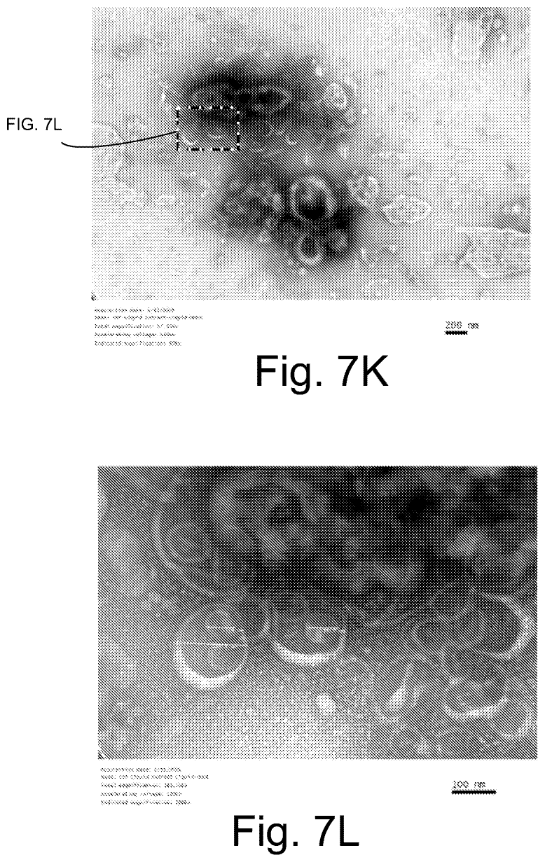

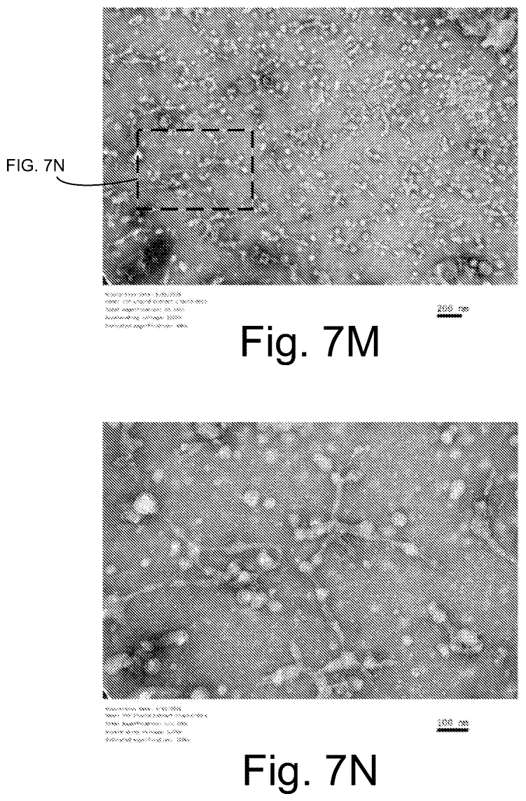

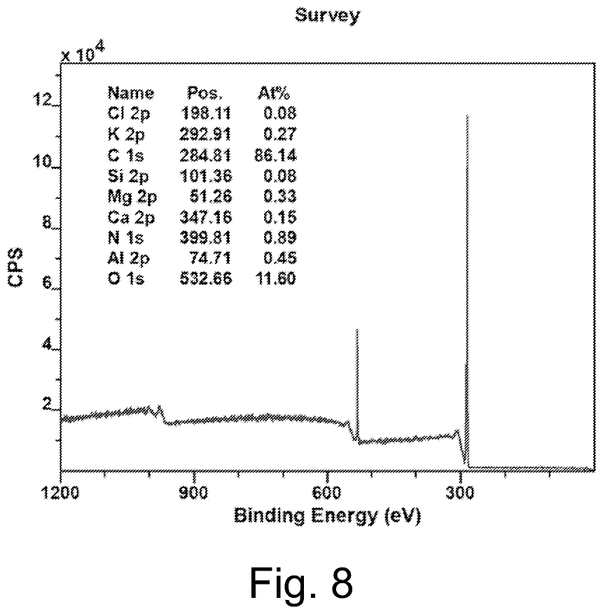

Disclosed herein is a machine 600 that can be used in the processes described herein. For example, a machine 600 for chemo-mechanical cellular explosion and/or a hydrodynamic cavitation reactor can be provided, as shown in FIG. 6. Machine 600 can include an inlet 610. The machine can include an outlet 620. The machine can include an interior chamber 630 connecting the inlet and the outlet, interior chamber 630 having an inner surface. The machine can include a shaft 640 spanning inlet 610, outlet 620, and interior chamber 630, shaft 640 having a plurality of threads disposed circumferentially around shaft 640, the plurality of threads having a first section and a second section. The first section of threads can have a first pitch and the second section of threads can have a second pitch different than the first pitch. For example, the first pitch can be greater than the second pitch.

Interior chamber 630 can further include one or more shearing members 632 disposed on the inner surface and corresponding to the second section of threads. For instance, the one or more shearing members 632 can include knife shears. Other forms of shearing members can be used in place of knife shears. The knife shears can be prepared at any height, length, or angle desired to achieve a shearing force between one or more shearing members 632 and the plurality of threads.

The shaft can be configured to rotate around a longitudinal axis shared with interior chamber 630, and the rotation can apply a shear force between the second section of threads and the one or more shearing members 632.

The machine can further include a protective shield 650 extending from an outer surface of machine 600 and substantially surrounding outlet 620, protective shield 650 having an interior space 652 between protective shield 650 and outlet 620. Machine 600 can also include an outlet gate 622 configured to control the size of the outlet. Outlet gate 622 can be configured to expand and/or contract to control the flow rate of material through machine 600.

As discussed above, some embodiments for making liquid product also include methods of manufacturing pellets. The method can involve first obtaining the dry pulp product discussed above. The process can then include applying a pressure to the dry pulp product to create a pressurized dry pulp product. The pressurized dry pulp product can then be fed through one or more apertures to generate pellets. The pellets can have many of the advantages discussed herein.

In some embodiments, increasing the pressure of the dry pulp product comprises passing the dry pulp product through a screw press. As used herein, the term screw press means any device having a chamber with an inlet, an outlet, and a threaded shaft passing therethrough, in which the threaded shaft (“screw”) is used to move material through the chamber. The shaft can have multiple sections with varying pitches on the threads for altering the pressures created in the dry pulp product at various locations within the chamber. An exemplary screw press is shown in FIG. 6. Thus, the dry pulp product can be fed into the inlet of the second screw press. As the shaft inside the chamber rotates, the dry pulp product is moved through the chamber while becoming more pressurized.

The second screw press can have a die positioned proximate the outlet of the chamber. The die can have a plurality of apertures extending therethrough. The pressurized dry pulp product can be fed through this die to create pellets. The die can have a first side positioned proximate the outlet of the chamber of the screw press and a second side distal opposite the first side. Channels can extend between the first side and second side to form the apertures. In some embodiments the cross-sectional area of the channels proximate the first side of the die can be greater than the cross-sectional area of the channels proximate the second side of the die.

In some embodiments, the process can further comprise adding a lubricant and/or a binder to the dry pulp product. The lubricant and/or binder can be mixed with dry pulp product prior to the dry pulp product entering the second screw press. In some embodiments, the lubricant and/or binder can be added to the inlet of the second screw press with the dry pulp product. The lubricant and/or binder can be any lubricants and/or binders known in the art. In some embodiments the lubricant and/or binder can be a polymer.

In any of the embodiments described herein, the liquid extract can be added to the input of the first screw press (to generate the liquid extract and dry pulp product) and/or to the input of the second screw press (to generate the pellets). In some embodiments the liquid extract is removed and help in a storage tank to be later added to the inlet of the first and/or second screw press. In some embodiments, the system can include a feedback loop in which at least a portion of the liquid extract generated by the first screw press can be recycled back into the input of the first screw press and/or second screw press. In some embodiments, the liquid extract added to the inlet of the first and/or second screw press can serve as a lubricant inside the chamber of the first and/or second screw press.

The system can further comprise a conveyor for transporting the dry pulp product from the outlet of the first screw press to the inlet of the second screw press. In some embodiments, the conveyor can comprise a mixer for mixing the dry pulp product with a lubricant and/or binder.

### EXAMPLES

The following examples are provided by way of illustration but not by way of limitation.

Over a period of one hour, 800 pounds of wood chips from biomass materials having an initial moisture content of 50% were conditioned by processes of the present disclosure to a moisture content of 18%, 48 kW in added energy was used in the process. As it was conveyed, the produced fiber then air-dried to 16% moisture content. It was milled to produce pellets having a pellet durability index of 99, a moisture content of 4%, and a bulk density of 750 kg/m³. When submersed in water for two minutes, the pellets exhibited very limited degradation. Steam was not injected during the conditioning process. Additional thermal energy was not added during pelletizing. Various liquid extracts were also produced from the conditioning that contained the following components and physical properties outlined in Tables 1-27.

In some examples, the liquid product can contain the following components and properties outlined in Table 1. Certain analytes were identified using official method AOAC 2011.14, applicable to analysis of calcium, copper, iron, potassium, magnesium, manganese, phosphorus, sodium, and zinc. Nutrient reports on a wet or liquid basis refer to the weight of nutrient per unit weight of wet sludge or liquid sample (e.g., pounds of nitrogen per ton of sample for broiler litter).

TABLE 1
Liquid Product Composition Example from
Loblolly Pine Biomass Materials

| | |
|---|---|
| Component | Percent Weight (liquid basis) |

| Humic Acid | 0.19-0.46% | |
|---|---|---|
| Fulvic Acid | 0.82-0.89% | |
| Kjeldahl Protein | 0.43% | |
| Moisture & Volatile Matter | 98.7% | |
| Fiber | 0.5% | |
| Calcium (AOAC 2011.14) | 148 | ppm |
| Phosphorus (AOAC 2011.14) | 40.1 | ppm |
| Sodium (AOAC 2011.14) | 210 | ppm |
| Potassium (AOAC 2011.14) | 553.3 | ppm |
| Magnesium (AOAC 2011.14) | 34.5 | ppm |
| Manganese (AOAC 2011.14) | 13 | ppm |
| Copper (AOAC 2011.14) | <10 | ppm |
| Zinc (AOAC 2011.14) | 5.2 | ppm |

| | |
|---|---|
| Hydroxyproline | 0.01% |
| Aspartic Acid | 0.01% |
| Glutamic Acid | 0.01% |
| Glycine | 0.01% |
| Alanine | 0.01% |
| Cysteine | 0.01% |
| Leucine | 0.01% |
| Tyrosine | 0.01% |
| Lysine | 0.01% |
| Tryptophan | <0.02% |

In some examples, the liquid product can contain the following components and properties outlined in Table 2. Certain analytes were identified using Inductively Coupled Plasma Optical Emission Spectroscopy (ICP-OES), applicable to determine amounts of elements present in a sample, such as calcium, copper, iron, potassium, magnesium, manganese, phosphorus, sodium, and zinc.

TABLE 2
Liquid Product Material Characterization
Example from Biomass Materials

| Analysis | Test Result | |
|---|---|---|
| Moisture | 98.4% (dried in oven set at 110° C.) | |
| Total Solid Suspension | 19.3 g/L (dried in oven set at 110° C.) | |
| Loss of Ignition | 96.8% (ignited at 550° C.) | |
| Total Carbon | 53 | wt. % |
| Total Nitrogen | 0.922 | wt. % |
| Calcium (ICP-OES) | 53.7 | mg/Kg |
| Sodium (ICP-OES) | 8.3 | mg/Kg |
| Potassium (ICP-OES) | 155.3 | mg/Kg |
| Magnesium (ICP-OES) | 15.9 | mg/Kg |
| Manganese (ICP-OES) | 8.3 | mg/Kg |
| Copper (ICP-OES) | 0.5 | mg/Kg |
| Iron (ICP-OES) | 23 | mg/Kg |
| Sulfur (ICP-OES) | 25.1 | mg/Kg |
| Silicon (ICP-OES) | 1.9 | mg/Kg |
| Aluminum (ICP-OES) | 4.1 | mg/Kg |
| Zinc (ICP-OES) | 0.8 | mg/Kg |
| Titanium (ICP-OES) | 0.1 | mg/Kg |
| Chromium (ICP-OES) | 1.2 | mg/Kg |
| Nickel (ICP-OES) | 0.9 | mg/Kg |
| Cobolt (ICP-OES) | 0.7 | mg/Kg |
| Molybdenum (ICP-OES) | 0.1 | mg/Kg |
| Barium (ICP-OES) | 0.5 | mg/Kg |

In some examples, the liquid product can contain the following components and properties outlined in Table 3. Nutrient reports on a wet or “as-is” basis refer to the weight of nutrient per unit weight of wet or “as-is” manure (e.g., pounds of nitrogen per ton of manure for broiler litter).

TABLE 3
Liquid Product Material Characterization
Example from Biomass Materials

| Analyte | Test Result (ppm) | Lbs / 1000 gallons |
|---|---|---|
| Nitrogen-Total | 929.0 | 7.75 |
| Ammonia Nitrogen | 262.0 | 2.19 |
| Nitrate (NO₃) | 216.0 | 1.80 |
| P₂O₅-Total | 118.82 | 0.99 |
| K₂O₀-Total | 238.04 | 1.99 |
| Sulfur | 22.66 | 0.19 |
| Boron | 0.322 | 0.00 |
| Zinc | 0.860 | 0.01 |
| Manganese | 4.97 | 0.04 |
| Iron | 6.17 | 0.05 |
| Copper | 0.140 | 0.00 |
| Calcium | 48.40 | 0.40 |
| Magnesium | 14.19 | 0.12 |
| Sodium | 4.52 | 0.04 |
| Aluminum | 4.99 | 0.04 |

In some examples, the liquid product can contain the following components and properties outlined in Table 4.

TABLE 4
Liquid Product Material Characterization Example
from Western Larch Timber Biomass Materials

| Analyte | Test Result (ppm) | Lbs / 1000 gallons |
|---|---|---|
| Nitrogen-Total | 2424.0 | 20.2162 |
| Ammonia Nitrogen | 1222.0 | 10.1915 |
| Nitrate (NO₃) | 951.0 | 7.9313 |
| P₂O₅-Total | 223.79 | 1.8664 |
| K₂O-Total | 532.93 | 4.4446 |
| Sulfur | 12.87 | 0.1073 |
| Boron | 1.18 | 0.0098 |
| Zinc | 2.04 | 0.0170 |
| Manganese | 14.84 | 0.1238 |
| Iron | 41.01 | 0.3420 |
| Copper | 1.04 | 0.0087 |
| Calcium | 207.34 | 1.7292 |
| Magnesium | 57.97 | 0.4835 |
| Sodium | 10.45 | 0.0872 |
| Aluminum | 8.34 | 0.0696 |

Additional Analyte

| | | |
|---|---|---|
| Humic Acid | 0.05% | — |

In some examples, the liquid product can contain the following components and properties outlined in Table 5.

TABLE 5
Liquid Product Material Characterization
Example from Hardwood Biomass Materials

| Analyte | Test Result (%) |
|---|---|
| Humic Acid | 0.46% |
| Fulvic Acid | 0.82% |

In some examples, the liquid product can contain the following components and properties outlined in Table 6.

TABLE 6
Liquid Product Material Characterization
Example from Softwood Biomass Materials

| Analyte | Test Result (%) |
|---|---|
| Humic Acid | 0.19% |
| Fulvic Acid | 0.89% |

In some examples, the liquid product can contain the following components and properties outlined in Table 7.

TABLE 7
Liquid Product Material Characterization
Example from Hemp Biomass Materials

| Nutrients | Test Result (%) |
|---|---|
| Boron (B) | 0.0029 |
| Calcium (Ca) | 0.2941 |
| Carbon (C) - Total | 6.01 |
| Copper (Cu) | 0.0004 |
| Iron (Fe) | 0.0031 |
| Magnesium (Mg) | 0.132 |
| Manganese (Mn) | 0.00009 |
| Molybdenum (Mo) | 0.00002 |
| Nitrogen (N) - Total | 0.654 |
| Phosphorus (P₂O₅) - Total | 0.0847 |
| Potassium (K₂O) - Total | 1.21 |
| Sulfur (S) | 0.158 |
| Zinc (Zn) | 0.0015 |
| Sodium (Na) | 0.129 |

In some examples, the liquid product can contain the following physical properties outlined in Table 8.

TABLE 8
Liquid Product Material Characterization
Example from Hemp Biomass Materials

| Analyte | Test Result (%) |
|---|---|
| Moisture | 84.58% |
| Solid | 1.20% |

In some examples, the liquid product can contain the following components and properties outlined in Table 9.

TABLE 9
Liquid Product Material Characterization
Example from Hemp Biomass Materials

| Analyte | Test Result (%) |
|---|---|
| Humic Acid | 0.27% |
| Fulvic Acid | 13.95% |

In some examples, the liquid product can contain the following components and properties outlined in Table 10. Certain analytes were identified using official method AOAC 2011.14, applicable to analysis of calcium, copper, iron, potassium, magnesium, manganese, phosphorus, sodium, and zinc.

TABLE 10
Liquid Product Material Characterization
Example from Biomass Materials

| Analyte | Test Result | |
|---|---|---|
| Kjeldahl Protein | 0.43% | |
| pH | 3.5 | |
| Moisture & Volatile Matter | 98.7% | |
| Fiber | 0.5% | |
| Calcium | 148.0 | ppm |
| Phosphorus | 40.1 | ppm |
| Sodium | 210.0 | ppm |
| Potassium | 553.3 | ppm |
| Magnesium | 34.5 | ppm |
| Manganese | 13.0 | ppm |
| Copper | <10.0 | ppm |
| Zinc | 5.2 | ppm |

In some examples, the liquid product can contain the following components and

TABLE 11
Liquid Product Material Fatty Acid Profile Characterization
Example from Biomass Materials

| Fatty Acid | Result |
|---|---|
| C4:0 Butyric | <0.01% |
| C5:0 Valeric | <0.01% |
| C6:0 Caproic | <0.01% |
| C7:0 Enanthic | <0.01% |
| C8:0 Caprylic | <0.01% |
| C9:0 Perlargonic | <0.01% |
| C10:0 Capric | <0.01% |
| C11:0 Undecanoic | <0.01% |
| C11:1 Undecylenoic | <0.01% |
| C12:0 Lauric | <0.01% |
| C12:1 Dodecenoic | <0.01% |
| C13:0 Tridecanoic | <0.01% |
| C13:1 Tridecenoic | <0.01% |
| C14:0 Myristic | <0.01% |
| C14:1 Myristoleic | <0.01% |
| C15:0 Pentadecanoic | <0.01% |
| C15:1 Pentadecenoic | <0.01% |
| C16:0 Palmitic | <0.01% |
| C16:1 Palmitoleic | <0.01% |
| C16:2 Hexadecadienoic | <0.01% |
| C16:4 Hexadecatetradienoic | <0.01% |
| C17:0 Margaric | <0.01% |
| C17:1 Margaroleic | <0.01% |
| C18:0 Stearic | <0.01% |
| C18:1 Oleic | <0.01% |
| C18:2 Linoleic | <0.01% |
| C18:2-CLA Conjugated Linoleic Acid | <0.01% |
| C18:3 Linolenic | <0.01% |
| C18:4 Octadecatetraenoic | <0.01% |
| C19:0 Nonadecanoic | <0.01% |
| C19:1 Nonadecenoic | <0.01% |
| C20:0 Arachidic | <0.01% |
| C20:1 Gadoleic | <0.01% |
| C20:2 Eicosadienoic | <0.01% |
| C20:3 Homo-y Linolenic | <0.01% |
| C20:4 Arachidonic | <0.01% |
| C20:5 Eicosapentaenoic | <0.01% |
| C21:5 Heneicosanoic | <0.01% |
| C22:0 Behenic | <0.01% |
| C22:1 Erucic | <0.01% |
| C22:2 Docosadienoic | <0.01% |
| C22:3 Docosatetraenoic | <0.01% |
| C22:4 Docosatetraenoic | <0.01% |
| C22:5 Docosapentaenoic | <0.01% |
| C22:6 Docosahexaenoic | <0.01% |
| C24:0 Lignoceric | <0.01% |
| C24:1 Nervonic | <0.01% |
| Other Fatty Acids | <0.01% |

In some examples, the liquid product can contain the following components and properties outlined in Table 12.

TABLE 12
Liquid Product Material Amino Acid Profile Characterization
Example from Biomass Materials

| Amino Acid | Result | Amino Acid | Result |
|---|---|---|---|
| Taurine | 0.00% | Methionine | 0.00% |
| Hydroxyproline | 0.01% | Isoleucine | 0.00% |
| Aspartic Acid | 0.01% | Leucine | 0.01% |
| Threonine | 0.00% | Tyrosine | 0.01% |
| Serine | 0.00% | Phenylalanine | 0.00% |
| Glutamic Acid | 0.01% | Hydroxylysine | 0.00% |
| Proline | 0.00% | Ornithine | 0.00% |
| Lanthionine | 0.00% | Lysine | 0.01% |
| Glycine | 0.01% | Histidine | 0.00% |
| Alanine | 0.01% | Arginine | 0.00% |
| Cysteine | 0.00% | Tryptophan | <0.02% |
| Valine | 0.00% | | |

In some examples, the liquid product collected from a hardwood biomass material can contain the following components and properties outlined in Tables 13-17. Nutrient reports on a dry basis refer to the weight of nutrient per unit weight of dry matter (% DM).

TABLE 13
Liquid Product Material Characterization
Example from Hardwood Biomass Materials

| Protein | % CP | % DM |
|---|---|---|
| Crude Protein | | 10.8 |
| Adjusted Protein | 84.8 | 9.2 |
| Soluble Protein | 84.8 | 9.2 |
| Acid Detergent Fiber Protein | 25.3 | 2.75 |
| Neutral Detergent Fiber Protein | 50.7 | 5.49 |

The Acid Detergent Fiber (ADF) measures the fibrous component in the sample. The ADF fiber represents the least digestible fiber portion of forage or other roughage. This highly in-digestible part of forage includes lignin, cellulose, silica and insoluble forms of nitrogen but not hemicellulose. Forages with higher ADF are lower in digestible energy than forages with lower ADF, which means that as the ADF level increases, digestible energy levels decrease. During laboratory analysis, ADF is the residue remaining after boiling a forage sample in acid detergent solution. ADF is often used to calculate digestibility, total digestible nutrients (TDN) and/or net energy for lactation. On the other hand, The Neutral Detergent Fiber (NDF) is the residue or insoluble fraction left after boiling a feed sample in neutral detergent solution. The NDF contains plant cell wall components except for some pectins. The NDF is considered a close estimate of the total fiber constituents of feedstuffs since it measures cellulose, hemicellulose, lignin, silica, tannins and cutins. NDF concentration is negatively correlated with dry matter intake (i.e., as NDF in the forage increases, animals will consume less forage). As a result, NDF is often used in formulas to predict the dry matter intake.

Acid detergent insoluble crude protein (ADICP) is the insoluble protein fraction remaining in the acid detergent fiber residue of a feed sample. ADICP escapes ruminal breakdown and represents the portion of the protein that is not degradable and is therefore unavailable to the animal. It also contains any heat-damaged protein that may result from heating during storage or processing. In this case, a portion of the protein reacts with carbohydrates (fiber) to form an indigestible complex, rendering it unavailable for digestion. This parameter is also reported as acid detergent insoluble protein (ADIP), acid detergent insoluble nitrogen (ADIN) or acid detergent fiber protein (ADFP). It is expressed as a percent of crude protein.

Dry matter (DM) represents everything contained in a feed sample except water; this includes protein, fiber, fat, minerals, etc. In practice, it is the total weight of feed minus the weight of water in the feed, expressed as a percentage (% DM). It is determined by drying the feed sample in an oven until the sample reaches a stable weight. This is normally a simple analysis. However, estimates of the DM of fermented materials such as silage are complicated by the presence of volatile fatty acids. These acids are removed in the drying process but they are part of the dry matter and are digestible.

TABLE 14
Liquid Product Material Characterization
Example from Hardwood Biomass

| Fiber | % NDF | % DM |
|---|---|---|
| ADF | 85.7 | 8.2 |
| Lignin | 72.47 | 6.97 |

Non-fibrous Carbohydrate (NFC) represents all forms of digestible carbohydrates that are solubilized after boiling a feed sample in neutral detergent solution. These are all forms of non-cell-wall carbohydrates and include starch, sugar, pectin and fermentation acids, which are digestible and serve as energy sources for the animal. NFC is calculated from the following equation:

$$NFC \% = 100 \% - [ CP \% + ( NDF \% - NDFICP \% ) + EE \% + Ash \% ] \qquad ( Eq . 1 )$$

Where EE % is the ether extract % or fat %.

TABLE 15
Liquid Product Material Characterization
Example from Hardwood Biomass Materials

| Carbohydrates | % NFC | % DM |
|---|---|---|
| Ethanol soluble CHO | 132.6 | 85.0 |
| Starch | 19.7 | 12.7 |
| Crude Fat | | 15.6 |

TABLE 16
Liquid Product Material Characterization
Example from Hardwood Biomass Materials

| Minerals | Test Result | |
|---|---|---|
| Ash | 5.26% | DM |
| Calcium | 0.88% | DM |
| Phosphorus | 0.35% | DM |
| Magnesium | 0.35% | DM |
| Potassium | 2.03% | DM |
| Sulfur | 0.32% | DM |
| Sodium | 0.20% | DM |
| Chloride | 2.52% | DM |
| Iron | 637 | ppm |
| Manganese | 367 | ppm |
| Zinc | 118 | ppm |
| Copper | 15 | ppm |

TABLE 17
Liquid Product Material Characterization
Example from Hardwood Biomass Materials

| Minerals | Test Result | |
|---|---|---|
| pH | 4.3 | |
| Total digestible nutrients | 98.9% | DM |
| Net energy lactation | 1.11 | Mcal/lb |
| Net energy gain | 0.83 | Mcal/lb |
| Non fiber carbohydrates | 64.13% | DM |
| Non-structural carbohydrates | 97.7% | DM |

In some examples, the liquid product collected from a first pine blend biomass material can contain the following components and properties outlined in Tables 18-22.

TABLE 18
Liquid Product Material Characterization Example
from First Pine Blend Biomass Materials

| Protein | % CP | % DM |
|---|---|---|
| Crude Protein | | 9.6 |
| Adjusted Protein | 76.7 | 7.4 |
| Soluble Protein | 33.2 | 3.2 |
| Acid Detergent Fiber Protein | 38.8 | 3.74 |
| Neutral Detergent Fiber Protein | 46.7 | 4.5 |

TABLE 19
Liquid Product Material Characterization
Example from First Pine Blend Biomass

| Fiber | % NDF | % DM |
|---|---|---|
| ADF | 79.1 | 17.2 |
| Lignin | 78.34 | 17.04 |

TABLE 20
Liquid Product Material Characterization Example
from First Pine Blend Biomass Materials

| Carbohydrates | % NFC | % DM |
|---|---|---|
| Ethanol soluble CHO | 3.3 | 1.8 |
| Starch | 0.2 | 0.1 |
| Crude Fat | | 11.30 |

TABLE 21
Liquid Product Material Characterization Example
from First Pine Blend Biomass Materials

| Minerals | Test Result | |
|---|---|---|
| Ash | 6.79% | DM |
| Calcium | 1.16% | DM |
| Phosphorus | 0.38% | DM |
| Magnesium | 0.27% | DM |
| Potassium | 1.95% | DM |
| Sulfur | 0.17% | DM |
| Sodium | 0.12% | DM |
| Chloride | 0.85% | DM |
| Iron | 969 | ppm |
| Manganese | 448 | ppm |
| Zinc | 1060 | ppm |
| Copper | 17 | ppm |

TABLE 22
Liquid Product Material Characterization Example
from First Pine Blend Biomass Materials

| Minerals | Test Result | |
|---|---|---|
| pH | 4.4 | |
| Total digestible nutrients | 79.3% | DM |
| Net energy lactation | 0.86 | Mcal/lb |
| Net energy gain | 0.59 | Mcal/lb |
| Non fiber carbohydrates | 55.03% | DM |
| Non-structural carbohydrates | 1.9% | DM |

In some examples, the liquid product collected from a second pine blend biomass material can contain the following components and properties outlined in Tables 23-27.

TABLE 23
Liquid Product Material Characterization Example
from Second Pine Blend Biomass Materials

| Protein | % CP | % DM |
|---|---|---|
| Crude Protein | | 12.9 |
| Adjusted Protein | 82.0 | 10.5 |
| Soluble Protein | 82.0 | 10.5 |
| Acid Detergent Fiber Protein | 30.0 | 3.86 |
| Neutral Detergent Fiber Protein | 43.8 | 5.63 |

TABLE 24
Liquid Product Material Characterization
Example from Second Pine Blend Biomass

| Fiber | % NDF | % DM |
|---|---|---|
| ADF | 66.1 | 17.4 |
| Lignin | 41.29 | 10.85 |

TABLE 25
Liquid Product Material Characterization Example
from Second Pine Blend Biomass Materials

| Carbohydrates | % NFC | % DM |
|---|---|---|
| Ethanol soluble CHO | 10.3 | 3.8 |
| Starch | 0.7 | 0.3 |
| Crude Fat | | 16.7 |

TABLE 26
Liquid Product Material Characterization Example
from Second Pine Blend Biomass Materials

| Minerals | Test Result | |
|---|---|---|
| Ash | 12.86% | DM |
| Calcium | 1.64% | DM |
| Phosphorus | 0.70% | DM |
| Magnesium | 0.57% | DM |
| Potassium | 3.98% | DM |
| Sulfur | 0.45% | DM |
| Sodium | 0.46% | DM |
| Chloride | 4.43% | DM |
| Iron | 1199 | ppm |
| Manganese | 745 | ppm |
| Zinc | 1911 | ppm |
| Copper | 21 | ppm |

TABLE 27
Liquid Product Material Characterization Example
from Second Pine Blend Biomass Materials

| Minerals | Test Result | |
|---|---|---|
| pH | 4.6 | |
| Total digestible nutrients | 80.3% | DM |
| Net energy lactation | 0.90 | Mcal/lb |
| Net energy gain | 0.62 | Mcal/lb |
| Non fiber carbohydrates | 36.98% | DM |
| Non-structural carbohydrates | 4.1% | DM |

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the various patent offices and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A liquid product obtained from a biomass material, the liquid product comprising one or more of water, bio-stimulant compounds, bio-nutrient compounds, minerals, amino acids, nano cellulose, lignin, hemicellulose, tannins, terpenes, polyphenol compounds, primary metabolites or secondary metabolites.

2. The liquid product of claim 1, wherein water is present in the liquid product in an amount from about 25% to about 99% by weight, based on the total weight of the liquid product; and wherein lignin is present in the liquid product in an amount from about 0.01% to about 75% by weight, based on the total weight of the liquid product.

3-6. (canceled)

7. The liquid product of claim 1, wherein lignin is present in the liquid product in an amount from about 0.1% to about 30% by weight, based on the total weight of dry matter (DM) of the liquid product.

8-9. (canceled)

10. The liquid product of claim 1, wherein the liquid product further comprises proteins and one or more volatile organic compounds (VOCs) or non-volatile organic compounds.

11. (canceled)

12. The liquid product of claim 1, wherein the liquid product further comprises one or more of catechin, taxifolin, procyanidin, caffeic, p-hydroxybenzoic acid, or ferulic acid.

13-15. (canceled)

16. The liquid product of claim 1, wherein potassium is present in the liquid product in an amount from about 0.1% to about 1.5% by weight, based on the total weight of dry matter (DM) of the liquid product.

17. The liquid product of claim 1, wherein phosphorus is present in the liquid product in an amount from about 1% to about 8% by weight, based on the total weight of dry matter (DM) of the liquid product.

18. The liquid product of claim 1, wherein nitrogen is present in the liquid product in an amount from about 500 parts per million (ppm) to about 4500 ppm, based on the total weight of liquid sample of the liquid product.

19. The liquid product of claim 1, wherein calcium is present in the liquid product in an amount from about 0.1% to about 3% by weight, based on the total weight of dry matter (DM) of the liquid product.

20. The liquid product of claim 1, wherein magnesium is present in the liquid product in an amount from about 0.1% to about 1.2% by weight, based on the total weight of dry matter (DM) of the liquid product.

21. The liquid product of claim 1, wherein sulfur is present in the liquid product in an amount from about 0.05% to about 1% by weight, based on the total weight of dry matter (DM) of the liquid product.

22. The liquid product of claim 1, wherein sodium is present in the liquid product in an amount from about 0.05% to about 1% by weight, based on the total weight of dry matter (DM) of the liquid product.

23. The liquid product of claim 1, wherein iron is present in the liquid product in an amount from about 300 parts per million (ppm) to about 4000 ppm, based on the total weight of dry matter (DM) of the liquid product.

24. The liquid product of claim 1, wherein manganese is present in the liquid product in an amount from about 150 parts per million (ppm) to about 1500 ppm, based on the total weight of dry matter (DM) of the liquid product.

25. The liquid product of claim 1, wherein zinc is present in the liquid product in an amount from about 50 parts per million (ppm) to about 4000 ppm, based on the total weight of dry matter (DM) of the liquid product.

26. The liquid product of claim 1, wherein copper is present in the liquid product in an amount from about 1 parts per million (ppm) to about 100 ppm, based on the total weight of dry matter (DM) of the liquid product.

27. The liquid product of claim 1, wherein the amino acids comprise one or more of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, or valine.

28. The liquid product of claim 1, wherein the bio-stimulant compounds comprise one or more of pipenes, camphenes, kaolins, polyacrylamides, humic acids, fulvic acids, or organic acids and are present in the liquid product in an amount from about 0.01% to about 20% by weight, based on the total weight of dry matter (DM) of the liquid product.

29. (canceled)

30. The liquid product of claim 28, wherein humic acid is present in the liquid product in an amount from about 0.001% to about 10% by weight, based on the total weight of dry matter (DM) of the liquid product; and wherein the fulvic acid is present in the liquid product in an amount from about 0.1% to about 20% by weight, based on the total weight of dry matter (DM) of the liquid product.

31. The liquid product of claim 1, wherein the liquid product has a pH from about 1 to about 7.

32-93. (canceled)
